(19) United States
(12) Patent Application Publication
(10) Pub. No.: US 2026/0016568 A1
(43) Pub. Date: Jan. 15, 2026

(54) APPARATUS, SYSTEM, AND METHOD OF DETERMINING A PREDICTED BEHAVIOR DETECTION BASED ON POINT CLOUD INFORMATION

(71) Applicant: MobilEye Vision Technologies Ltd., Jerusalem (IL)

(72) Inventors: Shachar Greenberg, Nofit (IL); Svetlana Raboy, Haifa (IL); Eran Gal-Ed, Kiryat Motzkin (IL); Yuval Avner, Haifa (IL)

(73) Assignee: MobilEye Vision Technologies Ltd., Jerusalem (IL)

(21) Appl. No.: 18/770,466

(22) Filed: Jul. 11, 2024

(51) Int. Cl. G01S 7/48; G01S 17/58; G01S 17/931

(52) U.S. Cl. CPC G01S 7/4802; G01S 17/58; G01S 17/931

(57) ABSTRACT

For example, a processor may be configured to process Point Cloud (PC) information including velocity information corresponding to a plurality of points. For example, velocity information corresponding to a point of the plurality of points may include a velocity value corresponding to the point. For example, the processor may be configured to identify a relative movement between a first element of a detected target and a second element of the detected target based on a first plurality of velocity values and a second plurality of velocity values. For example, the first plurality of velocity values may correspond to a plurality of first points corresponding to the first element, and the second plurality of velocity values may correspond to a plurality of second points corresponding to the second element. For example, the processor may determine a predicted behavior detection corresponding to the detected target, for example, based on the relative movement.

### BACKGROUND

Various types of devices and systems, for example, autonomous and/or robotic devices, e.g., autonomous vehicles and robots, may be configured to perceive and navigate through their environment using sensor data of one or more sensor types.

For example, autonomous perception techniques may utilize light-based sensors, such as image sensors, e.g., cameras, and/or Light Detection and Ranging (LiDAR) sensors, for example, to determine the range and/or velocity of objects.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation.

Furthermore, reference numerals may be repeated among the figures to indicate corresponding or analogous elements. The figures are listed below.

FIG. 1 is a schematic block diagram illustration of a vehicle implementing a light-based sensor, in accordance with some demonstrative aspects.

FIG. 2 is a schematic block diagram illustration of a robot implementing a light-based sensor, in accordance with some demonstrative aspects.

FIG. 3 is a schematic block diagram illustration of a light-based sensor apparatus, in accordance with some demonstrative aspects.

FIG. 4 is a schematic illustration of a light-based sensor, in accordance with some demonstrative aspects.

FIG. 5 is a schematic illustration of a light-based sensor, in accordance with some demonstrative aspects.

FIG. 6 is a schematic illustration of a digital processor, in accordance with some demonstrative aspects.

FIG. 7 is a schematic illustration of a light-based sensor device, in accordance with some demonstrative aspects.

FIG. 8A is a schematic illustration of Point Cloud (PC) information of a PC frame, in accordance with some demonstrative aspects.

FIG. 8B is a schematic illustration of segmentation of the PC frame of FIG. 8A, in accordance with some demonstrative aspects.

FIG. 8C is a schematic illustration of processed PC information based on the PC frame of FIG. 8A, in accordance with some demonstrative aspects.

FIG. 8D is a schematic illustration of processed PC information based on the PC frame of FIG. 8A, in accordance with some demonstrative aspects.

FIG. 9 is a schematic block diagram illustration of a system, in accordance with some demonstrative aspects.

FIG. 10 is a schematic flow-chart illustration of a method of determining a predicted behavior detection based on Point Cloud (PC) information, in accordance with some demonstrative aspects.

FIG. 11 is a schematic flow-chart illustration of a method of determining a predicted behavior detection based on PC information, in accordance with some demonstrative aspects.

FIG. 12 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a light-based sensor, a light-based sensor device, a light-based sensor system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with light-based sensor systems, vehicular light-based sensor systems, Light Detection And Ranging (LiDAR) systems, vehicular sensor systems, autonomous systems, robotic systems, detection systems, or the like.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting and/or emitting the signal, and/or receiving and/or detecting the signal. For example, a communication unit, which is capable of communicating a signal, may include a transmitter and/or emitter to transmit and/or emit the signal, and/or a receiver and/or detector to receive and/or detect a signal. The verb communicating may be used to refer to the action of transmitting/emitting or the action of receiving/detecting. In one example, the phrase “communicating a transmission signal” may refer to the action of transmitting/emitting the signal by a first device, and may not necessarily include the action of receiving/detecting the signal by a second device. In another example, the phrase “communicating a transmission signal” may refer to the action of receiving/detecting the signal by a first device, and may not necessarily include the action of transmitting/emitting the signal by a second device.

For example, the term “communicating” as used herein with respect to a light signal includes transmitting and/or emitting the light signal, and/or receiving and/or detecting the light signal. For example, a communication unit, which is capable of communicating a light signal, may include an emitter to emit the light signal, and/or a detector to detect and/or receive the light signal. The verb communicating may be used to refer to the action of transmitting/emitting or the action of receiving/detecting. In one example, the phrase “communicating a light signal” may refer to the action of transmitting/emitting the signal by a first device, and may not necessarily include the action of receiving/detecting the light signal by a second device. In another example, the phrase “communicating a light signal” may refer to the action of receiving/detecting the light signal by a first device, and may not necessarily include the action of transmitting/emitting the light signal by a second device.

Some demonstrative aspects are described herein with respect to light-based systems, for example, utilizing light-based sensors, e.g., Light Detection And Ranging (LiDAR) systems, utilizing light signals. However, other aspects may be implemented with respect to, or in conjunction with, any other signals, e.g., radar signals, sonar systems, wireless signals, IR signals, acoustic signals, optical signals, wireless communication signals, communication scheme, network, standard, and/or protocol.

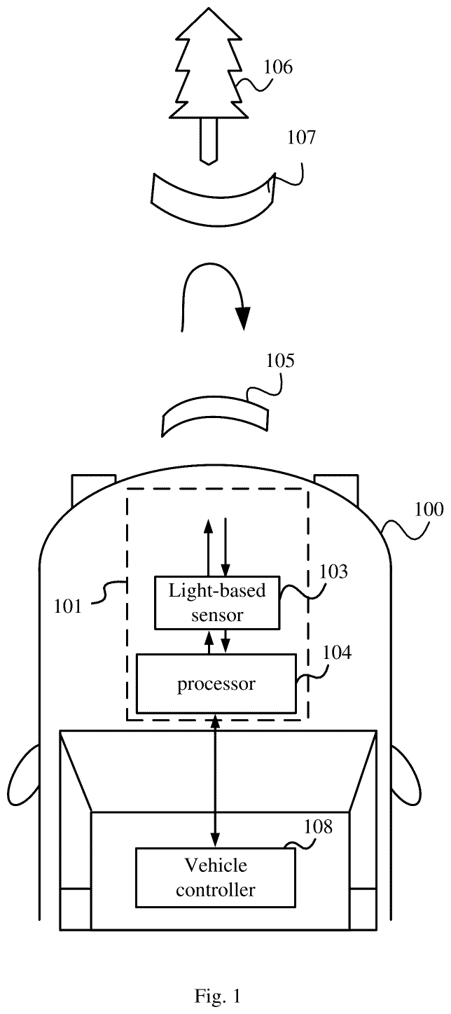

Reference is now made to FIG. 1, which schematically illustrates a block diagram of a vehicle 100 implementing a light-based sensor, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a light-based sensor device 101, e.g., as described below. For example, light-based sensor device 101 may include a light-based sensor detecting device, a light-based sensing device, a light-based sensor, or the like, e.g., as described below.

In some demonstrative aspects, light-based sensor device 101 may include a Light Detection and Ranging (LiDAR) sensor device.

In some demonstrative aspects, light-based sensor device 101 may include a Frequency Modulated Continuous Wave (FMCW) LiDAR sensor device, e.g., as described below.

In other aspects, light-based sensor device 101 may include any other suitable type of light-based sensor device.

In some demonstrative aspects, light-based sensor device 101 may be implemented as part of a vehicular system, for example, a system to be implemented and/or mounted in vehicle 100.

In one example, light-based sensor device 101 may be implemented as part of an autonomous vehicle system, an automated driving system, an assisted vehicle system, a driver assistance and/or support system, and/or the like.

For example, light-based sensor device 101 may be installed in vehicle 100 for detection of nearby objects, e.g., for autonomous driving.

In some demonstrative aspects, light-based sensor device 101 may be configured to detect targets in a vicinity of vehicle 100, e.g., in a far vicinity and/or a near vicinity, for example, using light waves and/or signals, e.g., as described below.

In one example, light-based sensor device 101 may be mounted onto, placed, e.g., directly, onto, or attached to, vehicle 100.

In some demonstrative aspects, vehicle 100 may include a plurality of light-based sensor devices 101. In other aspects, vehicle 100 may include a single light-based sensor device 101.

In some demonstrative aspects, vehicle 100 may include a plurality of light-based sensor devices 101, which may be configured to cover a field of view of 360 degrees around vehicle 100.

In other aspects, vehicle 100 may include any other suitable count, arrangement, and/or configuration of light-based sensor devices and/or units, which may be suitable to cover any other field of view, e.g., a field of view of less than 360 degrees.

In some demonstrative aspects, light-based sensor device 101 may be implemented as a component in a suite of sensors used for driver assistance and/or autonomous vehicles.

In some demonstrative aspects, light-based sensor device 101 may be configured to support autonomous vehicle usage, e.g., as described below.

In one example, light-based sensor device 101 may determine a class, a location, a distance, a range, an orientation, a velocity, an intention, a perceptional understanding of the environment, and/or any other information corresponding to an object in the environment.

In another example, light-based sensor device 101 may be configured to determine one or more parameters and/or information for one or more operations and/or tasks, e.g., path planning, and/or any other tasks.

In some demonstrative aspects, light-based sensor device 101 may be configured to map a scene by measuring targets' reflectivity and discriminating them, for example, mainly in range, velocity, azimuth and/or elevation, e.g., as described below.

In some demonstrative aspects, light-based sensor device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, light-based sensor device 101 may include a light-based sensor 103 configured to communicate light signals, e.g., as described below.

In some demonstrative aspects, light-based sensor device 101 may include a processor 104, which may be configured to generate light-based sensor information based on the light signals, e.g., as described below.

In some demonstrative aspects, processor 104 may be configured to process the light-based sensor information of light-based sensor device 101 and/or to control one or more operations of light-based sensor device 101, e.g., as described below.

In some demonstrative aspects, processor 104 may include, or may be implemented, partially or entirely, by circuitry and/or logic, e.g., one or more processors including circuitry and/or logic, memory circuitry and/or logic. Additionally or alternatively, one or more functionalities of processor 104 may be implemented by logic, which may be executed by a machine and/or one or more processors, e.g., as described below.

In one example, processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, processor 104 may be implemented by one or more additional or alternative elements of vehicle 100.

In some demonstrative aspects, light-based sensor 103 may include a LiDAR sensor, e.g., as described below.

In some demonstrative aspects, light-based sensor 103 may include an FMCW LiDAR sensor, e.g., as described below.

In other aspects, light-based sensor 103 may include any other additional type of light-based sensor configured to generate light-based sensor information based on sensed and/or detected light.

In some demonstrative aspects, light-based sensor 103 may include, for example, one or more light transmitters, and/or a one or more light receivers/detectors, e.g., as described below.

In some demonstrative aspects, as shown in FIG. 1, the light-based sensor 103 may be controlled, e.g., by processor 104, to transmit a light signal 105.

In some demonstrative aspects, as shown in FIG. 1, the light signal 105 may be reflected by an object 106, resulting in reflected light 107.

In some demonstrative aspects, the light-based sensor device 101 may receive the reflected light 107, e.g., via light-based sensor 103, and processor 104 may generate sensor information, for example, by calculating information about position, radial velocity, and/or direction of the object 106, e.g., with respect to vehicle 100.

In some demonstrative aspects, processor 104 may be configured to provide the sensor information to a vehicle controller 108 of the vehicle 100, e.g., for autonomous driving of the vehicle 100.

In some demonstrative aspects, at least part of the functionality of processor 104 may be implemented as part of vehicle controller 108. In other aspects, the functionality of processor 104 may be implemented as part of any other element of light-based sensor device 101 and/or vehicle 100. In other aspects, processor 104 may be implemented, as a separate part of, or as part of any other element of light-based sensor device 101 and/or vehicle 100.

In some demonstrative aspects, vehicle controller 108 may be configured to control one or more functionalities, modes of operation, components, devices, systems and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a user interface, a steering system, a braking system, a driving system, and/or any other system of the vehicle 100.

In some demonstrative aspects, vehicle controller 108 may configured to control light-based sensor device 101, and/or to process one or parameters, attributes and/or information from light-based sensor device 101.

In some demonstrative aspects, vehicle controller 108 may be configured, for example, to control the vehicular systems of the vehicle 100, for example, based on the sensor information from light-based sensor device 101 and/or one or more other sensors of the vehicle 100, e.g., radar sensors, camera sensors, and/or the like.

In one example, vehicle controller 108 may control the user interface, the steering system, the braking system, and/or any other vehicular systems of vehicle 100, for example, based on the information from light-based sensor device 101, e.g., based on one or more objects detected by light-based sensor device 101.

In other aspects, vehicle controller 108 may be configured to control any other additional or alternative functionalities of vehicle 100.

Some demonstrative aspects are described herein with respect to a light-based sensor device 101 implemented in a vehicle, e.g., vehicle 100.

In other aspects a light-based sensor device, e.g., light-based sensor device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place.

In one example, light-based sensor device 101 may be part of a non-vehicular device, which may be implemented, for example, in an indoor location, a stationary infrastructure outdoors, or any other location.

In another example, light-based sensor device 101 may be part of a mobile or non-mobile device. For example, light-based sensor device 101 may be implemented as part of a smartphone, a tablet, a computing device, or the like.

In another example, light-based sensor device 101 may be part of an optical device. For example, light-based sensor device 101 may be implemented as part of a camera, a spectrometer, a microscope, or the like.

In some demonstrative aspects, light-based sensor device 101 may be configured to support security usage. In one example, light-based sensor device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, light-based sensor device 101 may be configured to support any other usages and/or applications.

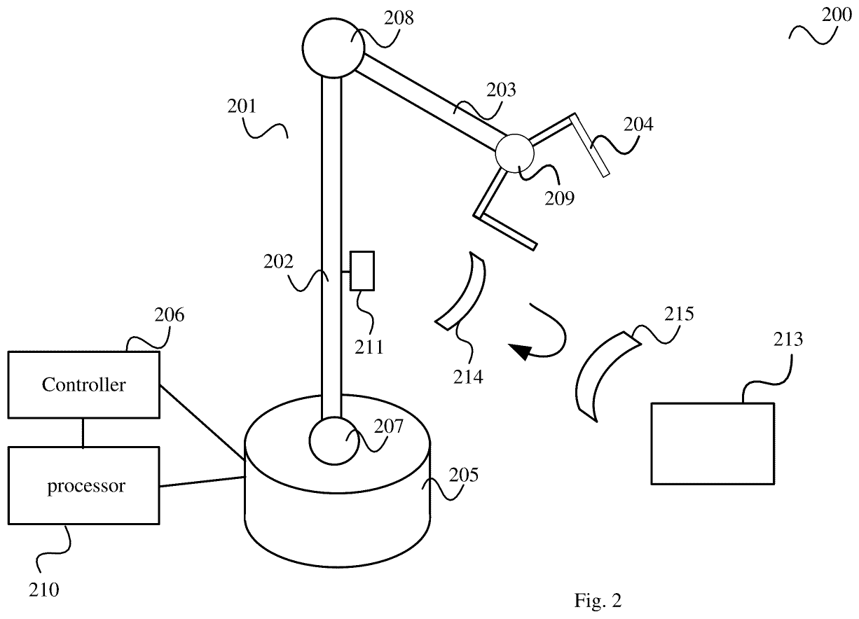

Reference is now made to FIG. 2, which schematically illustrates a block diagram of a robot 200 implementing a light-based sensor 211, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e., actuated).

In some demonstrative aspects, controller 206 may be in communication with a processor 210 of the robot 200.

In some demonstrative aspects, light-based sensor 211 may be coupled to the processor 210. In one example, light-based sensor 211 may be included, for example, as part of the robot arm 201.

In some demonstrative aspects, the light-based sensor 211, and the processor 210 may be operable as, and/or may be configured to form, a light-based sensor device. For example, light-based sensor 211 may be configured to perform one or more functionalities of light-based sensor 103 (FIG. 1), and/or processor 210 may be configured to perform one or more functionalities of processor 104 (FIG. 1), e.g., as described above.

In some demonstrative aspects, light-based sensor 211 may include a LiDAR sensor, e.g., as described below.

In some demonstrative aspects, light-based sensor 211 may include an FMCW LiDAR sensor, e.g., as described below.

In other aspects, light-based sensor 211 may include any other additional type of light-based sensor configured to generate light-based sensor information based on sensed and/or detected light.

In some demonstrative aspects, for example, the light-based sensor 211 may be controlled, e.g., by processor 210, to transmit a light signal 214.

In some demonstrative aspects, as shown in FIG. 2, the light signal 214 may be reflected by the object 213, resulting in reflected light 215.

In some demonstrative aspects, the reflected light 215 may be received, e.g., via light-based sensor 211, and processor 210 may generate sensor information, for example, by calculating information about position, speed and/or direction of the object 213, e.g., with respect to robot arm 201.

In some demonstrative aspects, processor 210 may be configured to provide the sensor information to the robot controller 206 of the robot arm 201, e.g., to control robot arm 201. For example, robot controller 206 may be configured to control robot arm 201 based on the sensor information, e.g., to grab the object 213 and/or to perform any other operation.

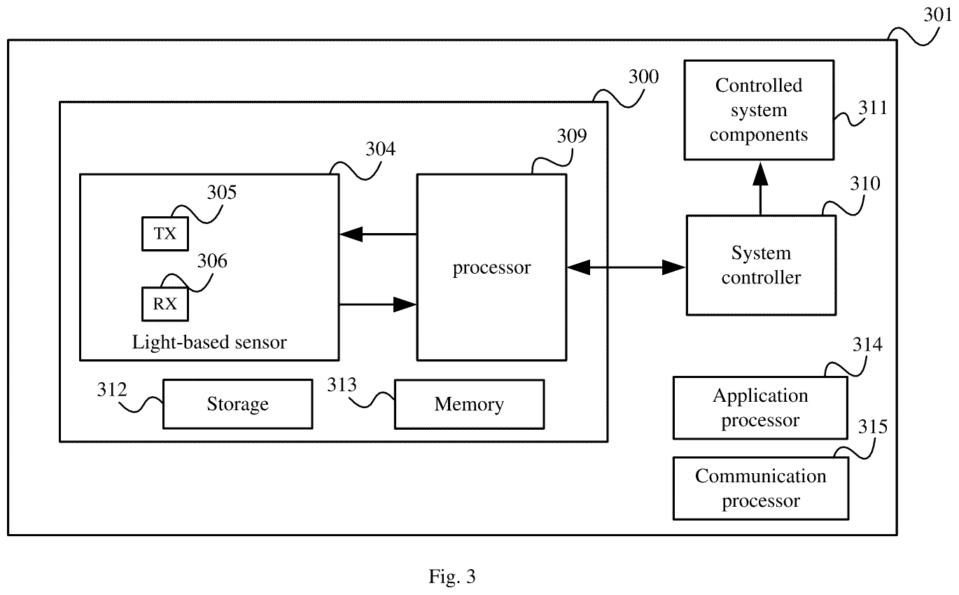

Reference is made to FIG. 3, which schematically illustrates a light-based sensor apparatus 300, in accordance with some demonstrative aspects.

In some demonstrative aspects, light-based sensor apparatus 300 may be implemented as part of a device or system 301, e.g., as described below.

For example, light-based sensor apparatus 300 may be implemented as part of, and/or may configured to perform one or more operations and/or functionalities of, the devices or systems described above with reference to FIG. 1 and/or FIG. 2. In other aspects, light-based sensor apparatus 300 may be implemented as part of any other device or system 301. For example, light-based sensor device 103 (FIG. 1), and/or light-based sensor 211 (FIG. 2), may include one or more elements of light-based sensor apparatus 300, and/or may perform one or more operations and/or functionalities of light-based sensor apparatus 300.

In some demonstrative aspects, light-based sensor device 300 may include a light-based sensor 304.

In some demonstrative aspects, light-based sensor 304 may include a LiDAR sensor, e.g., as described below.

In some demonstrative aspects, light-based sensor 304 may include an FMCW LiDAR sensor, e.g., as described below.

In other aspects, light-based sensor 304 may include any other additional type of light-based sensor configured to generate light-based sensor information based on sensed and/or detected light.

In some demonstrative aspects, as shown in FIG. 3, light-based sensor 304 may include a light transmitter 305 and a light receiver 306, e.g., as described below.

In some demonstrative aspects, light transmitter 305 may include one or more elements, for example, a light source, optic elements, and/or one or more other elements, configured to generate light signals to be emitted by the light-based sensor 304.

In some demonstrative aspects, light-based sensor device 300 may include a processor 309.

In some demonstrative aspects, for example, processor 309 may provide digital transmit data values to the light-based sensor 304.

In some demonstrative aspects, receiver 306 may include one or more elements, for example, one or more photo detectors, one or optical elements and/or one or more other elements, configured to detect and/or process, light signals received by light receiver 306.

In some demonstrative aspects, for example, light receiver 306 may be configured to convert a detected light signal into digital reception data values based on the detected light. For example, light-based sensor 304 may provide the digital reception data values to the processor 309.

In some demonstrative aspects, processor 309 may be configured to process the digital reception data values, for example, to detect one or more objects, e.g., in an environment of the device/system 301. This detection may include, for example, the determination of information including one or more of range, speed, direction, and/or any other information, of one or more objects, e.g., with respect to the system 301.

In some demonstrative aspects, processor 309 may be configured to provide the determined sensor information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the determined sensor information from processor 309 may be processed, e.g., by system controller 310 and/or any other element of system 301, for example, in combination with information from one or more other information sources, for example, radar information from a radar processor, vision information from a vision-based processor, or the like.

In some demonstrative aspects, an environmental model of an environment of system 301 may be determined, e.g., by system controller 310 and/or any other element of system 301, for example, based on the determined sensor information from processor 309, and/or the information from one or more other of information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, a steering system, and the like, e.g., by one or more corresponding actuators, for example, based on the one or more action decisions.

In some demonstrative aspects, light-based sensor device 300 may include a storage 312 and/or a memory 313, e.g., to store information processed by apparatus 300, for example, digital reception data values being processed by the processor 309, sensor information generated by processor 309, and/or any other data to be processed by processor 309.

In some demonstrative aspects, device/system 301 may include, for example, an application processor 314 and/or a communication processor 315, for example, to at least partially implement one or more functionalities of system controller 310 and/or to perform communication between system controller 310, light-based sensor device 300, the controlled system components 311, and/or one or more additional elements of device/system 301.

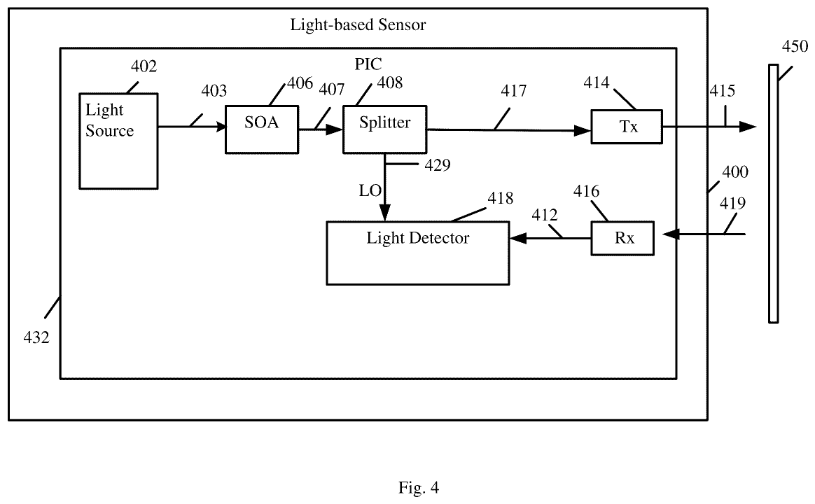

Reference is made to FIG. 4, which schematically illustrates a light-based sensor 400, in accordance with some demonstrative aspects.

For example, light-based sensor device 103 (FIG. 1), light-based sensor 211 (FIG. 2), and/or light-based sensor 304 (FIG. 3), may include one or more elements of light-based sensor 400, and/or may perform one or more operations and/or functionalities of light-based sensor 400.

In some demonstrative aspects, light-based sensor 400 may include a LiDAR sensor.

In some demonstrative aspects, light-based sensor 400 may include an FMCW LiDAR sensor.

In other aspects, light-based sensor 410 may include any other additional or alternative type light-based sensor, which may be configured to generate sensor information, for example, based on light transmitted and/or received by light-based sensor 410.

In some demonstrative aspects, light-based sensor 400 may include a Photonics Integrated Circuit (PIC) 432.

In some demonstrative aspects, PIC 432 may be formed on a semiconductor substrate e.g., a silicon-based substrate.

In some demonstrative aspects, light-based sensor 400 may include an optical Tx interface 414, which may be configured to emit an emitted light 415, e.g., a laser light. For example, light transmitter 305 (FIG. 3) may include one or more elements of optical Tx interface 414, and/or may perform one or more operations and/or functionalities of optical Tx interface 414.

In some demonstrative aspects, light-based sensor 400 may include one or more optical components 450, which may be configured to direct the laser light towards a specific direction, or a target. For example, the one or more optical components 450 may include a scan mirror.

In one example, optical Tx interface 414 may include one or more lens, and/or grating structures, which may be configured to guide the laser light from the optical Tx interface 414 to the one or more optical components 450.

In some demonstrative aspects, light-based sensor 400 may include an optical Rx interface 416, which may be configured to receive reflections 419 of the emitted light 415, which may be reflected from a target. For example, light receiver 306 (FIG. 3) may include one or more elements of optical Rx interface 416, and/or may perform one or more operations and/or functionalities of optical Rx interface 416.

In some demonstrative aspects, light-based sensor 410 may include a light detector 418, which may be configured to detect received light 412 via the optical Rx interface 418.

In some demonstrative aspects, the received light 412 may be based on the reflections 419 of the emitted light 415 from the target.

In one example, optical Rx interface 416 may include one or more lens, and/or one or more grating structures, which may be configured to guide the reflections 419 of the emitted light 415 from the or more optical components 450 to the light detector 418.

In one example, the optical Rx interface 416 and/or the optical Tx interface 414 may include one or more of a converging lens, a collimating lens, a diverging lens, or any other type of lens.

In one example, the optical Rx interface 416 and/or the optical Tx interface 414 may include one or more of a transmission grating, a reflective grating, a grism, and/or any other type of grating structures.

In some demonstrative aspects, light-based sensor 400 may include at least one light source 402, which may be configured to provide a light output 403.

In some demonstrative aspects, the emitted light 415 emitted by the optical Tx interface 414 may be based on the light output 403 from the light source 402.

In some demonstrative aspects, light-based sensor 400 may include an optical amplifier, e.g., a Silicon Optical Amplifier (SOA) 406 and/or any other type of optical amplifier, which may be configured to provide amplified light 407, for example, by amplifying the light output 403 from the light source 402.

In some demonstrative aspects, light-based sensor 400 may include a splitter 408, which may be configured to split the amplified light 407 into a first amplified light 417 and a second amplified light 429.

In some demonstrative aspects, the first amplified light 417 may be used as input light to the optical Tx interface 414.

In some demonstrative aspects, the second amplified light 429 may be used as an input Local Oscillator (LO) signal 429 to light detector 418.

In some demonstrative aspects, light detector 418 may be configured to use the input LO signal 429, for example, to determine differences between the received light 412 and the emitted light 415.

For example, light detector 418 may be configured to use the input LO signal 429, for example, to consider temporal fluctuations of the emitted light 415, for example, to detect and/or discriminate an optical frequency of the received light 412.

In some demonstrative aspects, processor 309 (FIG. 3) may be configured to provide detection information, for example, including one or more of range, speed, direction, and/or any other information with respect to one or more targets, for example, by processing the received light 412 and the LO signal 429.

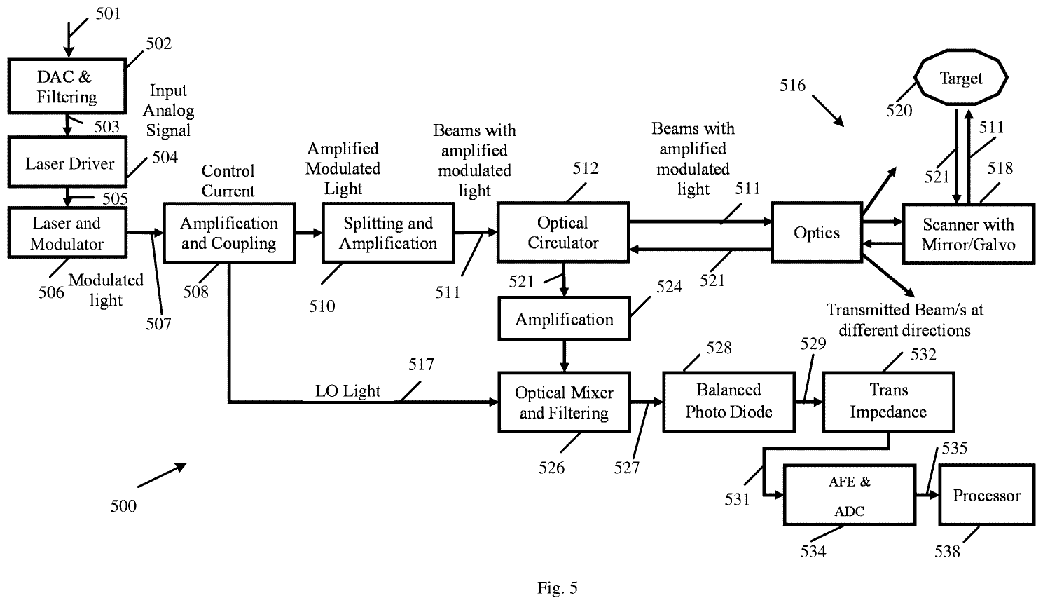

Reference is made to FIG. 5, which schematically illustrates a light-based sensor 500, in accordance with some demonstrative aspects. For example, light-based sensor 400 (FIG. 4) may include one or more elements of light-based sensor 500, and/or may be configured to perform one more operations and/or functionalities of light-based sensor 500.

In some demonstrative aspects, as shown in FIG. 5, light-based sensor 500 may include a Digital to Analog Converter (DAC) 502, which may be configured to generate an analog signal 503, for example, based on a digital input signal 501, which may be provided, for example, by a processor, e.g., processor 309 (FIG. 3).

In some demonstrative aspects, the analog signal 503 may be represented as a current signal or as a voltage signal.

In some demonstrative aspects, DAC 502 may be configured to filter the analog signal 503, for example, to a certain bandwidth (BW), e.g., for reduction of noise.

In some demonstrative aspects, as shown in FIG. 5, light-based sensor 500 may include a laser driver 504, which may be configured to generate a laser driving signal 505, for example, based on the analog signal 503.

In some demonstrative aspects, as shown in FIG. 5, light-based sensor 500 may include a laser generator/modulator 506, which may be configured to generate a modulated laser signal 507, for example, according to the laser driving signal 505.

In some demonstrative aspects, laser generator/modulator 506 may be configured to modulate the laser signal 507, for example, to change an immediate frequency and/or a phase of the laser signal 507.

In one example, modulated laser signal 507 may include an FMCW laser signal. For example, the FMCW laser signal 507 may be generated according to a chirping technique.

In one example, a phase, denoted ϕₜₓ(t), of a transmitted FMCW laser signal may be modeled, for example, after pre-distortion of the FMCW signal or in an ideal case, e.g., as follows:

$${ϕ}_{tx} ( t ) = 2 π ( \frac{1}{2} β {t}^{2} + {f}_{c} t ) + {ϕ}_{0} + {n}_{pn} \qquad ( 1 )$$

wherein fc denotes a carrier frequency of the transmitted FMCW laser signal, β denotes a slope rate (slop rate) of a chirp of the transmitted FMCW laser signal, ϕ₀ denotes an initial phase, and nₚₙ denotes a phase noise of the laser.

In some demonstrative aspects, modulated laser signal 507 may include coherent light, for example, having the phase ϕₜₓ(t).

In one example, light-based sensor 500 may utilize more than one, e.g., several, laser signals having one or more wavelengths. For example, the laser signals may be combined or selected, e.g., on the fly, in an optical domain of the laser system, e.g., by one or more suitable switches and/or combiners.

In some demonstrative aspects, modulated laser signal 507 may be split and/or amplified, for example, to provide a plurality of beams of laser light 511.

In one example, the plurality of beams of laser light 511 may be utilized, for example, to gain spread in a scanned dimension, e.g., a vertical dimension and/or a horizontal dimension.

In some demonstrative aspects, as shown in FIG. 5, light-based sensor 500 may include an amplifier 508, which may be configured to amplify the modulated laser signal 507.

In some demonstrative aspects, as shown in FIG. 5, light-based sensor 500 may include a splitter 510, which may be configured to split the modulated laser signal 507, for example, into the plurality of beams of laser light 511.

In some demonstrative aspects, the plurality of beams of laser light 511 may be transmitted via a circulator 512 and one or more optical components 516, which may be configured to direct and/or shape the plurality of beams of laser light 511, for example, towards a specific direction, e.g., towards a target 520.

For example, the one or more optical components 516 may include a scan mirror 518. For example, scan mirror 518 may include, for example, a Galvanometer (Galvo) scanner, a one-dimension (1D) mirror scanner, and/or any other type of optic scanner.

In some demonstrative aspects, as shown in FIG. 5, a reflected light 521 may be reflected from the target 520. For example, reflected light 521 may include a portion of the plurality of beams of laser light 511, which may be reflected from the target 520.

In some demonstrative aspects, as shown in FIG. 5, the reflected light 521 may be reflected all the way back to the circulator 512, e.g., via the one or more optical components 516.

In some demonstrative aspects, circulator 512 may be configured to separate between the reflected light 521 and the plurality of beams of laser light 511.

In other aspects, circulator 512 may be excluded from light-based sensor 500, for example, in case another LiDAR detection technique is implemented. In one example, light-based sensor 500 may be configured to implement a bi-static design.

In some demonstrative aspects, as shown in FIG. 5, light-based sensor 500 may include an amplifier 524, which may be configured to amplify the reflected light 521.

In some demonstrative aspects, as shown in FIG. 5, light-based sensor 500 may include a mixer 526, which may be configured to mix the reflected light 521, for example, with a Local Oscillator (LO) signal 517, for example, to generate a down-converted signal 527, e.g., a low frequency signal, for example, based on mixing and filtering of the reflected light 521 and the LO signal 517.

In some demonstrative aspects, as shown in FIG. 5, LO signal 517 may include a copy of the modulated laser signal 507, which may be coupled from the modulated laser signal 507, e.g., by a coupler 508.

In other aspects, LO signal 517 may be implemented using any other suitable signal, e.g., a CW laser signal without modulation.

In other aspects, a de-chirping operation may be performed in the digital domain, for example, in implementations where the reflected light 521 is not mixed with the LO signal 517.

In some demonstrative aspects, down-converted signal 527 may represent, for example, a range function, denoted R(t), corresponding to a range of the target 520 with a velocity, denoted V, e.g., as follows:

$$R ( t ) = α sin ( 2 π {f}_{b} t + ϕ ) + n ( t ) \qquad ( 2 )$$

wherein α denotes a factor, which may be based on a signal power of the down converted signal 527, an intensity of a free space loss, a coupling efficiency, and/or the like;
wherein n(t) denotes noise, for example, including noise, which with good design may be dominated by a shot noise of the laser, or by any other factor;
wherein f_{b} denotes a beating frequency, which may be determined, e.g., as follows:

$${f}_{b} = \frac{2 R}{c} β - \frac{2 v}{λ} \qquad ( 3 )$$

wherein λ denotes a wavelength of the modulated laser signal 507, and c denotes the speed of light.

In some demonstrative aspects, as shown in FIG. 5, light-based sensor 500 may include one or more photodiodes 528, e.g., Balance Photo Diodes (BPD), which may be configured to convert down-converted signal 527 into a current signal 529.

In some demonstrative aspects, as shown in FIG. 5, light-based sensor 500 may include a Trans Impedance Amplifier (TIA) 532, which may be configured to translate the current signal 529 into a voltage signal 531, and to amplify the voltage signal 531.

In some demonstrative aspects, as shown in FIG. 5, light-based sensor 500 may include an Analog Front End (AFE) and Analog to Digital (ADC) block 534, for example, including an AFE and an ADC. For example, the AFE may be configured to amplify and filter the voltage signal 531, and the ADC may be configured to sample the voltage signal 531, for example, to generate a digital signal 535.

In some demonstrative aspects, as shown in FIG. 5, light-based sensor 500 may include a digital processor 538, which may be configured to process the digital signal 535. For example, digital processor 538 may include an Application Specific Integrated Circuit (ASIC), a Field Programmable Gate Arrays (FPGA) processor, a general purpose processing unit, and/or any other type of processor.

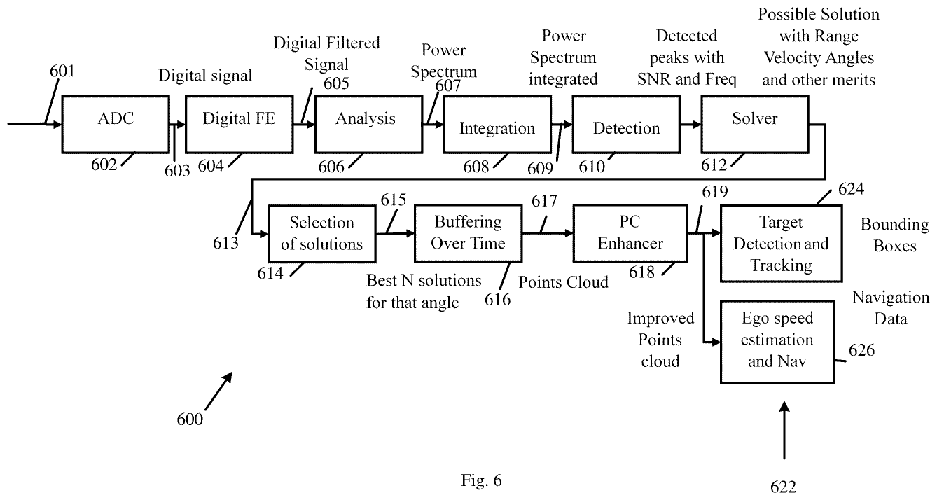

Reference is made to FIG. 6, which schematically illustrates a digital processor 600, in accordance with some demonstrative aspects. For example, digital processor 538 (FIG. 5) may include one or more elements of digital processor 600, and/or may be configured to perform one more operations and/or functionalities of digital processor 600.

In some demonstrative aspects, digital processor 600 may be configured to process a digital signal 605, e.g., digital signal 535 (FIG. 5).

In some demonstrative aspects, digital signal 605 may be provided, for example, based on an analog signal 601.

For example, an ADC 602 may convert the analog signal 601 into a digital signal 603, and a Digital Front End (DFE) 604 may be configured to amplify and filter the digital signal 603.

In some demonstrative aspects, as shown in FIG. 6, digital processor 600 may include a frequency analyzer 606, which may be configured to generate a power spectrum 607, for example, based on the digital signal 605.

In one example, frequency analyzer 606 may determine the power spectrum 607, for example, by applying a Fast Fourier Transform (FFT).

In some demonstrative aspects, the power spectrum 607 may be utilized, for example, in order to detect a beat frequency.

In some demonstrative aspects, as shown in FIG. 6, digital processor 600 may include an integrator 608, for example, to integrate the power spectrum 607, and to provide an integrated power spectrum 609. For example, integrator 608 may average an absolute value of the FFT, for example, for enhancement of a detection rate of the beat frequency, for example, to provide the integrated power spectrum 609.

In some demonstrative aspects, as shown in FIG. 6, digital processor 600 may include a detector 610, which may be configured, for example, to detect one or more peaks in the integrated power spectrum 609.

In one example, detector 610 may detect a plurality of peaks, which may potentially include a peak (target-based peak), which may have been created by a target at the beat frequency.

In one example, a transmitted laser signal may include a plurality of chirps having a plurality of different slop rates. For example, the transmitted laser signal may include a first chirp having a first slop rate, denoted β¹, and a second chirp having a second slop rate, denoted β².

According to this example, a set of equations may be formed, for example, including a first equation corresponding to a first beat frequency, denoted

$${f}_{b}^{1} ,$$

of a first peak based on the first chirp, and a second equation corresponding to a second beat frequency, denoted

$${f}_{b}^{2} ,$$

of a second peak based on the second chirp, e.g., as follows:

$${f}_{b}^{1} = \frac{2 R}{c} {β}^{1} - \frac{2 v}{λ} \qquad ( 4 )$$

$${f}_{b}^{2} = \frac{2 R}{c} {β}^{2} - \frac{2 v}{λ}$$

In some demonstrative aspects, the Equation set (4) may be solved, for example, to provide a solution to detect the target at the beat frequency.

In one example, a polarity of the frequency may be distinguished in the Equation set (4), for example, in case an In-phase-Quadrature (IQ) receiver is implemented in an optic domain, e.g., to apply two chains on the same signal.

In another example, positive and negative signs may be considered for the Equation set (4), for example, in case an IQ receiver is not implemented.

In some demonstrative aspects, as shown in FIG. 6, digital processor 600 may include a solver 612, which may be configured to solve one or more sets of equations, for example, to determine a plurality of possible solutions corresponding to one or more targets. For example, solver 612 may solve the set of Equations (4).

In some demonstrative aspects, solver 612 may be configured to provide information 613 with respect to the plurality of possible solutions corresponding to the one or more targets.

In some demonstrative aspects, a possible solution corresponding to a target may be determined based on a range of the target and/or a velocity of the target, e.g., provided by solver 612.

In some demonstrative aspects, a possible solution corresponding to a target may be determined based on an azimuth angle of the target, and/or an elevation angle of the target, e.g., provided by a scan mirror, e.g., scan mirror 512 (FIG. 5).

In some demonstrative aspects, a possible solution corresponding to a target may be determined based on a peak amplitude of a peak corresponding to the target, e.g., provided by detector 610.

In other aspects, a possible solution corresponding to a target may include any other information with respect to the target.

In some demonstrative aspects, as shown in FIG. 6, digital processor 600 may include a selector 614, which may be configured to select one or more possible solutions 615 from the plurality of possible solutions identified based on the information 613.

In one example, selector 614 may be configured to select a particular number, denoted N, of solutions, e.g., N best solutions, from the plurality of possible solutions.

In another example, selector 614 may be configured to select a single best solution from the plurality of possible solutions.

In another example, selector 614 may be configured to select the one or more possible solutions 615 from the plurality of possible solutions, for example, according to any other suitable method, criterion, and/or parameter.

In some demonstrative aspects, digital processor 600 may be configured to execute one or more, e.g., some or all, of the operations of the target detection procedure described above, for example, repeatedly, with respect to a plurality of scanned azimuth angles and/or scanned elevation angles, e.g., over an entire Field of View (FoV), for example, to create Point Cloud (PC) information 617.

In some demonstrative aspects, as shown in FIG. 6, digital processor 600 may include a buffer 616, which may be configured to collect and store the selected possible solutions 615 over the FoV, for example, to provide the PC information 617.

In some demonstrative aspects, as shown in FIG. 6, digital processor 600 may include a PC enhancer 618, which may be configured to enhance the PC information 617, and to provide enhanced PC information 619, for example, based on the PC information 617.

In one example, PC enhancer 618 may be configured to detect false alarms, to correct miss-detections, to correct errors in the PC information 617, and/or to apply any other additional or alternative PC enhancement techniques.

In some demonstrative aspects, as shown in FIG. 6, digital processor 600 may include one or more post processing algorithms 622, which may be configured to process the PC information 617 and/or enhanced PC information 619, for example, for object detection, for road user detection, for tracking, and/or the like.

In one example, the one or more post processing algorithms 622 may include one or more target detection and classification algorithms 624, which may be configured to create bounding boxes and target identifiers (ID), e.g., per target.

In another example, the one or more post processing algorithms 622 may include one or more navigation algorithms 626, which may be configured to determine navigation data, for example, based on PC information 617 and/or enhanced PC information 619, and one or more other types of information, e.g., Doppler data, and/or Inertial Measurement Unit (IMU) information. For example, the navigation data may be utilized to determine a location of a device or system, e.g., including light-based sensor device 300 (FIG. 3), e.g., a real-world absolute location, or a relative-location with respect to a starting point.

In some demonstrative aspects, a system, e.g., as described above with reference to FIGS. 1-6, may be configured to implement one or more operations and/or functionalities of a behavior-prediction mechanism, which may be configured to predict a behavior of one or more objects, e.g., as described below.

In some demonstrative aspects, the one or more objects may include one or detected targets, which may be detected based on the PC information.

In some demonstrative aspects, the one or more detected targets may include, for example, one or more vehicles, e.g., cars, vans, busses, and/or the like.

In some demonstrative aspects, the one or more detected targets may include, for example, one or more humans, for example, road users, e.g., pedestrians, bicycle riders, skaters, runners, and/or the like.

In some demonstrative aspects, a system, e.g., as described above with reference to FIGS. 1-6, may be configured to implement one or more operations and/or functionalities of a behavior-prediction mechanism, which may be configured to provide a technical solution to provide a prediction, e.g., a high quality prediction, of current and/or future behavior of the detected targets, e.g., as described below.

In some demonstrative aspects, the prediction of the current and/or future behavior of the detected targets may be utilized to provide a technical solution to support understanding of future actions of the detected targets, e.g., as described below.

In some demonstrative aspects, the prediction of the current and/or future behavior of the detected targets may be utilized to provide a technical solution to support a good vehicle, e.g., an improved, control policy, e.g., as described below.

In some demonstrative aspects, the behavior-prediction mechanism may be implemented to provide a technical solution to support risk mitigation, for example, by adapting one or more policy decisions, for example, based on the current and/or future behavior of the detected targets, e.g., as described below.

In one example, the prediction of the current and/or future behavior of the detected targets may be implemented to provide a technical solution to reduce risks for a detected target, e.g., a human and/or a vehicle, and/or for the ego vehicle. For example, the prediction of the current and/or future behavior of a detected target may be utilized to reduce risk for the ego vehicle and/or the detected target, for example, by avoiding a collision between an ego vehicle, e.g., vehicle 101 (FIG. 1), and the detected target.

In some demonstrative aspects, the behavior-prediction mechanism may be implemented to provide a technical solution to support improved one or more Key Performance Indicators (KPI) of a product or a system, e.g., as described below.

In some demonstrative aspects, the behavior-prediction mechanism may be implemented to provide a technical solution to predict a future behavior of a detected target, for example, in one or more use cases, e.g., as described below.

In one example, the behavior-prediction mechanism may be configured to support prediction of a beginning of a movement of a pedestrian, e.g., as described below.

For example, the behavior-prediction mechanism may be configured to predict when a pedestrian is going to cross a road.

In another example, the behavior-prediction mechanism may be configured to predict a movement and a direction of the movement of a pedestrian, e.g., as described below.

For example, the behavior-prediction mechanism may be configured to predict when a skater is going to turn, and/or in which direction.

In another example, the behavior-prediction mechanism may be configured to predict a movement of an element of a vehicle, e.g., as described below.

For example, the behavior-prediction mechanism may be configured to predict an opening of a door of a vehicle, e.g., as described below.

In another example, the behavior-prediction mechanism may be configured to predict a movement of a human inside a vehicle, e.g., as described below.

For example, the behavior-prediction mechanism may be configured to predict an exit of a human from the vehicle, e.g., as described below.

In other aspects, the behavior-prediction mechanism may be configured to predict any other additional or alternative movement and/or action corresponding to one or more detected targets.

In some demonstrative aspects, for example, in some use cases, scenarios, and/or implementations, there may be one or more technical issues, for example, in implementations relying only on ToF-based information to predict the behavior of a detected target, e.g., as described below.

For example, the ToF-based information may be provided by ToF-based systems including, for example, a camera-based system, a ToF-based LiDAR, and/or a ToF based radar, which may be configured to provide range information.

For example, the ToF-based information may be processed by one or more PC perception algorithms, which may be programmed to rely on the ToF-based information, e.g., in the form of an angle-distance-intensity description of space. For example, in some implementations, the angle-distance-intensity description of space may be the sole available data from a ToF sensor.

For example, the PC perception algorithms may be based on motion vectors, classification of road users, and behavioral modeling.

For example, it may be very hard to predict a behavior of a detected target, e.g., based solely on the ToF-based information, for example, in one or more use cases.

For example, in many use cases it may be practically impossible to predict the future behavior of a detected target, e.g., quickly and/or reliably, for example, when relying solely on the ToF-based information.

For example, PC perception algorithms, which rely solely on the ToF-based information, may be capable of predicting a position and/or a future motion of a detected target, for example, only after the beginning of the motion of the detected target.

For example, some prediction algorithms may be based on optical flow information (optical-flow prediction algorithms), which may be obtained by tracking a detected target across multiple frames. However, the optical-flow prediction algorithms may be limited to very high-resolution data, may require a large number of frames, and/or may be committed to per-point tracking of the detected object. For example, these limitations may make the optical-flow prediction algorithms very hard to implement for real time systems.

In some demonstrative aspects, a system, e.g., as described above with reference to FIGS. 1-6, may be configured to implement one or more operations and/or functionalities of a behavior-prediction mechanism, which may be configured to provide a technical solution to predict a behavior of a detected target, for example, quickly, e.g., in real time, and/or with a high degree of accuracy and/or reliability, e.g., as described below.

In some demonstrative aspects, the behavior-prediction mechanism may be configured to provide a technical solution to support prediction of the behavior of the detected target, for example, based on PC information of a reduced number of PC frames, e.g., as described below.

For example, the behavior-prediction mechanism may be configured to provide a technical solution to predict a behavior of a detected target, for example, in an a-priori manner, e.g., before the detected target actually performs an actual movement, e.g., as described below.

For example, the behavior-prediction mechanism may be configured to provide a technical solution to predict a behavior of a detected target, for example, with a high level of precision and/or with a low level of false-alarms, e.g., as described below.

In some demonstrative aspects, the PC information may include PC information provided by a LiDAR-based system, e.g., PC information 617 (FIG. 6) and/or enhanced PC information 619 (FIG. 6), e.g., as described above.

In some demonstrative aspects, the PC information may include PC information, which may be based on the PC information provided by the LiDAR-based system, and on PC information provided by one or more additional sensors, e.g., camera-based sensors, radar-based sensors, or the like.

In other aspects, the PC information may include PC information, which may be based on information from one or more additional or alternative types of sensors.

In some demonstrative aspects, the behavior-prediction mechanism may be configured to provide a technical solution to support prediction of the behavior of the detected target, for example, based on PC information of less than 10 PC frames, e.g., as described below.

In some demonstrative aspects, the behavior-prediction mechanism may be configured to provide a technical solution to support prediction of the behavior of the detected target, for example, based on PC information of no more than 5 PC frames, e.g., as described below.

In some demonstrative aspects, the behavior-prediction mechanism may be configured to provide a technical solution to support prediction of the behavior of the detected target, for example, based on PC information of no more than 3 PC frames, e.g., as described below.

In some demonstrative aspects, the behavior-prediction mechanism may be configured to provide a technical solution to support prediction of the behavior of the detected target, for example, based on PC information of no more than 2 PC frames, e.g., as described below.

In some demonstrative aspects, the behavior-prediction mechanism may be configured to provide a technical solution to support prediction of the behavior of the detected target, for example, based on PC information of a single PC frame, e.g., as described below.

In some demonstrative aspects, the behavior-prediction mechanism may be configured to provide a technical solution to support prediction of the behavior of the detected target, for example, based on PC information including velocity information, e.g., as described below.

In some demonstrative aspects, the behavior-prediction mechanism may be configured to provide a technical solution to support prediction of the behavior of the detected target, for example, based on PC information including Doppler information, e.g., as described below.

In some demonstrative aspects, the behavior-prediction mechanism may be configured to provide a technical solution to support prediction of a behavior of a detected target, for example, based on information corresponding to one or more elements of the detected target, e.g., as described below.

In some demonstrative aspects, the behavior-prediction mechanism may be configured to provide a technical solution to support prediction of a behavior of a detected target, for example, based on detected movements of one or more elements of the detected target, e.g., as described below.

In some demonstrative aspects, the behavior-prediction mechanism may be configured to provide a technical solution to support prediction of a behavior of a detected target, for example, based on a detected relative movement between two or more elements of the detected target, e.g., as described below.

In some demonstrative aspects, the behavior-prediction mechanism may be configured to provide a technical solution to support prediction of a behavior of a detected target, for example, based on a detected relative movement between an element of the detected target and the detected target, e.g., as described below.

In some demonstrative aspects, the behavior-prediction mechanism may be configured to provide a technical solution to support prediction of a behavior of a detected target, for example, based on relatively slow movements of one or more elements of the detected target, e.g., as described below.

In some demonstrative aspects, the behavior-prediction mechanism may be configured to provide a technical solution to support prediction of a behavior of a detected target, for example, based on a relatively slow movement of an element of the detected target relative to another element of the detected target, e.g., as described below.

In some demonstrative aspects, the behavior-prediction mechanism may be configured to provide a technical solution to support prediction of a behavior of a detected target, for example, based on a relative velocity of less than 20 centimeters (cm) per second (sec) (cm/sec) between two elements of the detected target, e.g., as described below.

In some demonstrative aspects, the behavior-prediction mechanism may be configured to provide a technical solution to support prediction of a behavior of a detected target, for example, based on a relative velocity of less than 10 cm/sec between two elements of the detected target, e.g., as described below.

In some demonstrative aspects, the behavior-prediction mechanism may be configured to provide a technical solution to support prediction of a behavior of a detected target, for example, based on a relative velocity of less than 7 cm/sec between two elements of the detected target, e.g., as described below.

In some demonstrative aspects, the behavior-prediction mechanism may be configured to provide a technical solution to support prediction of a behavior of a detected target, for example, based on a relative velocity of less than 5 cm/sec between two elements of the detected target, e.g., as described below.

In some demonstrative aspects, the behavior-prediction mechanism may be configured to provide a technical solution to support prediction of a behavior of a detected target, for example, based on a relative velocity of less than 3 cm/sec between two elements of the detected target, e.g., as described below.

In some demonstrative aspects, the behavior-prediction mechanism may be configured to provide a technical solution to support prediction of a behavior of a detected target, for example, based on velocity information of one or more elements of the detected target, e.g., as described below.

In some demonstrative aspects, the behavior-prediction mechanism may be configured to provide a technical solution to support prediction of a behavior of a detected human, for example, based on velocity information of one or more body parts of the human, e.g., as described below.

In some demonstrative aspects, the behavior-prediction mechanism may be configured to provide a technical solution to support prediction of a behavior of a detected human, for example, based on relatively small velocity changes along a body of the detected human, e.g., as described below.

For example, these relatively small velocity changes along the body of the detected human may be created, for example, when the human performs various types of movement, e.g., as described below.

In one example, limbs of a human may move up and down, for example, when the human is walking, while a torso of the human may maintain a constant speed.

In another example, hands of the human may move forward and backward, for example, while the human is walking.

In another example, shoulders of a human may move in opposite directions, for example, when the human is making a turn, e.g., while walking or running. For example, these movements may result in different Doppler values between the shoulders. For example, one shoulder may have a positive Doppler, while the other shoulder may have a negative Doppler, e.g., compared to an average Doppler of a whole body of the human.

In another example, a human may perform small movements, e.g., leaning forward and backward, for example, when the human hesitates whether or not to perform a movement, e.g., to cross a road. For example, these movements may result in micro Doppler effects corresponding to the human body.

In some demonstrative aspects, the behavior-prediction mechanism may be configured to provide a technical solution to support prediction of a behavior of a human in a detected vehicle, for example, based velocity changes of one or more elements of the vehicle, e.g., as described below.

In another example, an opening of a sliding door of a vehicle may create relatively large Doppler effects, e.g., due to the movement of the sliding door relative to the vehicle. For example, these Doppler effects may not be accompanied by any meaningful range difference, e.g., between a range of the sliding door and the range of the vehicle. For example, the detection of this type of Doppler effects may be utilized to predict behavior of a human in the vehicle, e.g., to predict that a passenger of the vehicle is about to exit the vehicle.

In some demonstrative aspects, the behavior-prediction mechanism may be configured to provide a technical solution to support prediction of a behavior of a detected human, for example, based on small movements of one or more body parts of the human body, for example, even in cases where the detected huma is at a relatively long range, e.g., as described below.

In some demonstrative aspects, a system, e.g., as described above with reference to FIGS. 1-6, may be configured to implement one or more operations and/or functionalities of a behavior-prediction mechanism, which may be configured to provide a technical solution to predict a behavior of a detected target, for example, based on PC information, which may include velocity information with a relatively high degree of accuracy, e.g., as described below.

In some demonstrative aspects, a light-based sensor, e.g., as described above with reference to FIGS. 1-6, may be configured to implement an FMCW light-based sensor, for example, an FMCW LiDAR sensor, e.g., as described above.

In some demonstrative aspects, the FMCW light-based sensor may be configured to provide Doppler information, for example, with a relatively high level of precision, e.g., a precision level in the order of (cm/sec).

In some demonstrative aspects, the FMCW light-based sensor may be configured to provide Doppler information, for example, with a relatively high level of resolution, for example, a resolution of less than 1 degree, for example, less than 0.5 degrees, e.g., a resolution of less than 0.1 degree, or any other suitable resolution.

In some demonstrative aspects, the behavior-prediction mechanism may be configured to provide a technical solution to support prediction of a behavior of a detected target, for example, based on the Doppler information having the relatively high precision and/or the relatively high resolution.

In one example, the behavior-prediction mechanism may be configured to detect even relatively small gestures, for example, based on the relatively high precision of the Doppler information.

For example, in many use cases, Doppler information with a precision of about +−5 cm/sec, or even about +−15 cm/sec may be sufficient to provide substantially instantaneous detection of a behavior of a detected target, e.g., as described below.

In some demonstrative aspects, a system, e.g., as described above with reference to FIGS. 1-6, may be configured to utilize the Doppler information, e.g., provided by the light-based FMCW sensor, may be utilized, for example, to predict an instantaneous behavior and/or a future behavior of detected targets, to classify detected targets, and/or to segment one or more elements within detected targets, e.g., as described below.

In some demonstrative aspects, the behavior-prediction mechanism may be configured to provide a technical solution to support prediction of a behavior of a detected target based on information provided by the light-based FMCW sensor, for example, with or without additional “external” information, for example, from one or more other types of sensors, e.g., a radar device, a camera device, and/or the like.

In some demonstrative aspects, the behavior-prediction mechanism may be configured to fuse the Doppler information with information from one or more external sources, e.g., radar information, camera information, Inertial Measurement Unit (IMU) information, and/or any other additional or alternative information from any other sources, for example, to predict the instantaneous behavior and/or future behavior of detected targets, to classify the detected targets, and/or to segment the one or more elements within the detected targets.

In some demonstrative aspects, the behavior-prediction mechanism may be configured to fuse the Doppler information of a detected target with previous information of the detected target. In one example, the Doppler information of a detected target may be fused with similar behavior of the same detected target in the past. In another example, the Doppler information of a detected target may be fused with information of other targets having a similar behavior in the past.

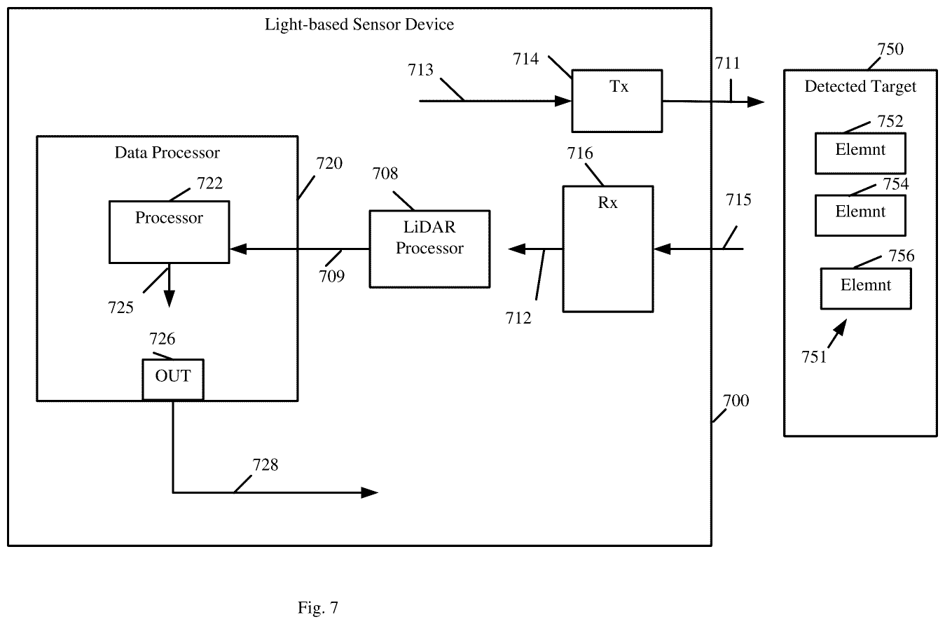

Reference is made to FIG. 7, which schematically illustrates a light-based sensor device 700, in accordance with some demonstrative aspects. For example, light-based sensor 500 (FIG. 5) may include one or more elements of light-based sensor device 700, and/or may be configured to perform one more operations and/or functionalities of light-based sensor device 700.

In some demonstrative aspects, light-based sensor device 700 may include a LiDAR sensor device, e.g., as described below.

In some demonstrative aspects, light-based sensor device 700 may include an FMCW LiDAR sensor device, e.g., as described below.

In other aspects, light-based sensor device 700 may include any other suitable type of light-based sensor device.

In some demonstrative aspects, light-based sensor device 700 may be configured to emit laser light 711, e.g., as described above.

In some demonstrative aspects, light-based sensor device 700 may be configured to detect reflected laser light 715, which may be based on the laser light reflected from a detected target 750, e.g., as described above.

In some demonstrative aspects, light-based sensor device 700 may include an optical Tx interface 714, which may be configured to emit the laser light 711, e.g., as described above.

In some demonstrative aspects, optical Tx interface 714 may be configured to emit the laser light 711 including LiDAR Tx signals 713.

In some demonstrative aspects, light-based sensor device 700 may include an optical Rx interface 716, which may be configured to receive LiDAR Rx signals 712, for example, based on reflections of the LiDAR Tx signals 713, for example, in the form of the reflected laser light 715, e.g., as described above.

For example, optical Tx interface 714 and/or optical Rx interface 716 may include one or more elements of optical components 516 (FIG. 5), and/or may be configured to perform one more operations and/or functionalities of optical components 516 (FIG. 5).

In some demonstrative aspects, the LiDAR Tx signals 713 and the LiDAR Rx signals 712 may include FMCW LiDAR signals, e.g., as described above.

In other aspects, the LiDAR Tx signals 713 and the LiDAR Rx signals 712 may include any other type of LiDAR signals.

In some demonstrative aspects, light-based sensor device 700 may include a data processor 720, which may be configured to process Point Cloud (PC) information 709, e.g., as described below.

In some demonstrative aspects, data processor 720 may be implemented, for example, as part of a digital processor, e.g., digital processor 538 (FIG. 5), and/or digital processor 600 (FIG. 6).

For example, data processor 720 may be implemented, for example, to execute and/or to perform the one or more post processing algorithms 622. For example, the PC information 709 may include the enhanced PC information 619 (FIG. 6).

In other aspects, data processor 720 may be implemented, for example, as part of any other element of light-based sensor device 500 (FIG. 5).

In some demonstrative aspects, the PC information 709 may include LiDAR PC information, e.g., as described below.

In some demonstrative aspects, the PC information 709 may include Frequency Modulated Continuous Wave (FMCW) LiDAR PC information of an FMCW LIDAR, e.g., as described below.

In other aspects, the PC information 709 may include any other type of information.

In some demonstrative aspects, the PC information 709 may be based on the LiDAR Rx signals 712.

In some demonstrative aspects, light-based sensor device 700 may include a LiDAR processor 708, which may be configured to generate the PC information 709, for example, based on the LiDAR Rx signals 712.

For example, LiDAR processor 708 may be implemented, for example, as part of PC enhancer 618, for example, to provide the PC information 709.

In other aspects, LiDAR processor 708 may be implemented, for example, as part of any other element of light-based sensor device 500 (FIG. 5).

In some demonstrative aspects, LiDAR processor 708 may be implemented, for example, as part of a digital processor, e.g., digital processor 538 (FIG. 5), and/or digital processor 600 (FIG. 6).

In some demonstrative aspects, data processor 720 may include an output 726, which may be configured to provide output information 728, for example, based on the PC information 709, e.g., as described below.

In some demonstrative aspects, output 726 may include any suitable output interface, output unit, output module, output component, output circuitry, memory interface, memory access unit, memory writer, digital memory unit, bus interface, processor interface, or the like, which may be capable of outputting the output information 728 to a memory, a processor, and/or any other suitable component to handle the output information 728.

In some demonstrative aspects, the output information 728 may be provided, for example, to a vehicle controller, e.g., vehicle controller 108 (FIG. 1), which may be configured to control one or more systems of the vehicle 101 (FIG. 1), for example, based on the output information 728.

In some demonstrative aspects, PC information 709 may include velocity information corresponding to a plurality of points, e.g., as described below.

In some demonstrative aspects, velocity information corresponding to a point of the plurality of points PC information 709 may include a velocity value corresponding to the point, e.g., as described below.

In some demonstrative aspects, the velocity information corresponding to the plurality of points may be based on Doppler information, e.g., micro Doppler information, corresponding to the plurality of points, e.g., as described below.

In some demonstrative aspects, a velocity value corresponding to a point may represent an estimated velocity corresponding to the point, e.g., based on a Doppler value, e.g., a micro Doppler value, corresponding to the point, e.g., as described below.

In some demonstrative aspects, the velocity value corresponding to the point may include an estimated and/or calculated velocity value, which may be determined and/or calculated, for example, based on the Doppler value corresponding to the point, e.g., as described below.

In some demonstrative aspects, the velocity value corresponding to the point may include the Doppler value corresponding to the point, for example, in the form of “raw” Doppler information, or processed, e.g., partially-processed or fully-processed, Doppler information.

In some demonstrative aspects, the velocity value corresponding to the point may include a Line-of-Sight (LoS) velocity value, which may include, or may be based on, Doppler information detected on a LoS between a detector, e.g., a LiDAR detector, and a detected object.

In other aspects, the velocity information corresponding to the plurality of points may include any other suitable additional or alternative type and/or form of velocity values.

In some demonstrative aspects, data processor 720 may include a processor 722, which may be configured to process the PC information 709 including the velocity information corresponding to the plurality of points, e.g., as described below.

In some demonstrative aspects, processor 722 may include, or may be implemented, partially or entirely, by circuitry and/or logic, e.g., one or more processors including circuitry and/or logic, memory circuitry and/or logic. Additionally or alternatively, one or more functionalities of processor 722 may be implemented by logic, which may be executed by a machine and/or one or more processors, e.g., as described below.

For example, processor 722 may include one or more CPUs, one or more Graphic Processing Units (GPUs), one or more Application Specific Integrated Circuits (ASICs), one or more Field Programmable Gate Arrays (FPGAs), and/or any other additional or alternative digital processing units.

In some demonstrative aspects, processor 722 may be configured to determine a predicted behavior detection 725 corresponding to the detected target 750, for example, based on PC information 709, e.g., as described below.

In some demonstrative aspects, processor 722 may be configured to determine a predicted behavior detection 725 corresponding to the detected target 750, for example, based on processing of PC information 709 of no more than 5 PC frames, e.g., as described below.

In some demonstrative aspects, processor 722 may be configured to determine a predicted behavior detection 725 corresponding to the detected target 750, for example, based on processing of PC information 709 of no more than 4 PC frames, e.g., as described below.

In some demonstrative aspects, processor 722 may be configured to determine a predicted behavior detection 725 corresponding to the detected target 750, for example, based on processing of PC information 709 of no more than 3 PC frames, e.g., as described below.

In some demonstrative aspects, processor 722 may be configured to determine the predicted behavior detection 725 corresponding to the detected target 750 based on processing of PC information 709 of no more than 2 PC frames, e.g., as described below.

In some demonstrative aspects, processor 722 may be configured to determine the predicted behavior detection 725 corresponding to the detected target 750 based on processing of PC information 709 of a single PC frame, e.g., as described below.

In some demonstrative aspects, the predicted behavior detection 725 may include, for example, a predicted movement of the detected target 750, e.g., as described below.

In some demonstrative aspects, the predicted movement of the detected target 750 may include, for example, a change in a direction of movement of the detected target 750, e.g., as described below.

In some demonstrative aspects, the predicted movement of the detected target 750 may include, for example, a start of movement of the detected target 750, e.g., as described below.

In other aspects, the predicted movement of the detected target 750 may include any other additional and/or alternative predicted type of movement of the detected target 750.

In some demonstrative aspects, the predicted behavior detection 725 may include a predicted behavior of at least one element 751 of the detected target 750, e.g., as described below.

In some demonstrative aspects, the predicted behavior of the at least one element 751 may include a predicted movement of the at least one element 751 relative to the detected target 750, e.g., as described below.

In other aspects, the predicted behavior of the at least one element 751 may include any other additional and/or alternative predicted type of movement of the at least one element 751.

In other aspects, the predicted behavior detection 725 may include any other additional and/or alternative type of prediction of any other additional or alterative type of behavior corresponding to the target 750.

In some demonstrative aspects, the detected target 750 may include a first element 752 and a second element 754, e.g., as described below.

In some demonstrative aspects, the detected target 750 may include a human, the first element 752 may include a first body part of the human, and/or the second element 754 may include a second body part of the human.

In some demonstrative aspects, the detected target 750 may include a vehicle, the first element 752 may include a first part of the vehicle, and/or the second element 754 may include a second part of the vehicle.

In some demonstrative aspects, the detected target 750 may include a vehicle, the first element 752 may include a part of the vehicle, and/or the second element 754 may include a human inside the vehicle.

In other aspects, the first element 752 and/or the second element 754 may include any other combination of any other type of elements, and/or parts, which may be defined with respect to the detected target 750.

In some demonstrative aspects, processor 722 may be configured to identify a relative movement between the first element 752 of the detected target 750 and the second element 754 of the detected target 750, for example, based on the PC information 709, e.g., as described below.

In some demonstrative aspects, processor 722 may be configured to determine the predicted behavior detection 725, for example, based on the relative movement between the first element 752 and the second element 754, e.g., as described below.

In some demonstrative aspects, processor 722 may be configured to identify the relative movement between the first element 752 of the detected target 750 and the second element 754 of the detected target 750, for example, based on a first plurality of velocity values and a second plurality of velocity values, for example, in the PC information 709, e.g., as described below.

In some demonstrative aspects, the first plurality of velocity values may include velocity values, e.g., in the PC information 709, which correspond to a plurality of first points corresponding to the first element 752, e.g., as described below.

In some demonstrative aspects, the second plurality of velocity values may include velocity values, e.g., in the PC information 709, which correspond to a plurality of second points corresponding to the second element 754, e.g., as described below.

In some demonstrative aspects, processor 722 may be configured to determine a predicted behavior detection 725, e.g., corresponding to the detected target 750, the first element 752, and/or the second element 754, for example, based on the relative movement between the first element 752 and the second element 754, e.g., as described below.

In some demonstrative aspects, processor 722 may be configured to control, instruct, and/or trigger output 726 to provide the output information 728, for example, based on the predicted behavior detection 725, e.g., as described below.

In some demonstrative aspects, processor 722 may be configured to determine the predicted behavior detection 725, for example, based on a direction of the relative movement between the first element 752 and the second element 754, e.g., as described below.

In some demonstrative aspects, processor 722 may be configured to determine a predicted angular movement of the detected target 750, for example, based on the relative movement between the first element 752 and the second element 754, e.g., as described below.

In some demonstrative aspects, processor 722 may be configured to determine the predicted behavior detection 725, for example, based on the predicted angular movement of the detected target 750, e.g., as described below.

In some demonstrative aspects, processor 722 may be configured to determine the predicted angular movement of the detected target 750, for example, based on identification of a first relative movement and a second relative movement, e.g., as described below.

In some demonstrative aspects, the first relative movement may include a movement between the first element 752 of the detected target 750 and the second element 754 of the detected target 750, e.g., as described below.

In some demonstrative aspects, the second relative movement may include a movement between a third element 756 of the detected target 750 and the second element 754 of the detected target 750, e.g., as described below.

In some demonstrative aspects, processor 722 may be configured to determine the predicted angular movement of the detected target 750, for example, based on identification that the first relative movement is in a direction substantially opposite to a direction of the second relative movement, e.g., as described below.

For example, processor 722 may be configured to identify that that detected target 750 includes a person.

For example, the processor 722 may be configured to determine whether the person is standing, walking, or running, for example, based on velocity information in the PC information 709, which corresponds to a body of the detected person.

For example, the processor 722 may be configured to determine a predicted angular movement of the detected person 750, for example, based on an identified movement of element 752, e.g., representing a first shoulder of the detected person, and an identified movement of element 756, e.g., representing a second shoulder of the detected person.

For example, processor 722 may be configured to identify a first relative movement of element 752, e.g., representing the first shoulder of the detected person, and element 754, e.g., representing a center of a body of the detected person.

For example, processor 722 may be configured to identify a second relative movement of element 756, e.g., representing the second shoulder of the detected person, and element 754, e.g., representing the center of a body of the detected person.

For example, processor 722 may be configured to identify the predicted angular movement of the detected person, for example, based on the identified relative movement of the first shoulder of the detected person, and the identified relative movement of the first shoulder of the detected person.

For example, processor 722 may be configured to identify the predicted angular movement of the detected person, for example, based on identification that the first relative movement, e.g., of the first shoulder relative to the body of the detected person, is in a direction substantially opposite to a direction of the second relative movement, e.g., of the second shoulder relative to the body of the detected person.

For example, processor 722 may be configured to determine a predicted behavior detection corresponding to the detected person, e.g., a predicted turn of the detected person, for example, based on the predicted angular movement of the detected person.

In one example, the detected person may make a turn of 30 degrees within one second, e.g., at an angular velocity of about ω=30 deg/1 sec=0.525 rad/sec. This angular velocity may be equivalent to a relative linear velocity between the two shoulders of the detected person, e.g., V₁=ω*r=0.52*0.2˜0.11 m/sec=11 cm sec, for example, assuming a distance of r=0.2 between a middle of the torso of and each shoulder of the person.

According to this example, processor 722 may be capable of determining the predicted turning of the detected person, for example, based on PC information including velocity information with a precision of 11 cm/sec or a better precision. For example, PC information including velocity information with a precision of 2 cm/sec, or even 5-10 cm/sec may be more than enough.

In other aspects, In some demonstrative aspects, processor 722 may be configured to determine the predicted angular movement of the detected target 750 based on any other additional or alternative information and/or criteria.

In some demonstrative aspects, processor 722 may be configured to determine a direction of the relative movement between the first element 752 and the second element 754, for example, based on the first plurality of velocity values and the second plurality of velocity values, e.g., as described below.

In some demonstrative aspects, processor 722 may be configured to determine the predicted behavior detection 725, for example, based on the direction of the relative movement between the first element 752 and the second element 754, e.g., as described below.

In some demonstrative aspects, processor 722 may be configured to determine a first movement vector corresponding to the first element 752, for example, based on the first plurality of velocity values corresponding to the first element 752, e.g., as described below.

In some demonstrative aspects, processor 722 may be configured to determine a second movement vector corresponding to the second element 754, for example, based on the second plurality of velocity values corresponding to the second element 754, e.g., as described below.

In some demonstrative aspects, processor 722 may be configured to determine the relative movement between the first element 752 and the second element 754, for example, based on the first movement vector and the second movement vector, e.g., as described below.

In some demonstrative aspects, processor 722 may be configured to determine a direction of the relative movement between the first element 752 and the second element 754, for example, based on a direction of the first movement vector and a direction of the second movement vector, e.g., as described below.

In some demonstrative aspects, processor 722 may be configured to determine the predicted behavior detection 725, for example, based on the direction of the relative movement between the first element 752 and the second element 754, e.g., as described below.

In some demonstrative aspects, processor 722 may be configured to determine a magnitude of the relative movement between the first element 752 and the second element 754, for example, based on a magnitude of the first movement vector and a magnitude of the second movement vector, e.g., as described below.

In some demonstrative aspects, processor 722 may be configured to determine the predicted behavior detection 725, for example, based on the magnitude of the relative movement between the first element 752 and the second element 754, e.g., as described below.

In some demonstrative aspects, processor 722 may be configured to determine the predicted behavior detection 725 to identify, for example, a predicted movement of a person about to cross a road, e.g., as described below.

For example, a person may make small “hesitation” movements, for example, by leaning a bit forward and a bit backward an upper part of the body. For example, these “hesitation” movements may include a forward movement of about 5 cm, e.g., during about half a second, and a backward movement of about 5 cm, e.g., during about half a second. These “hesitation” movements may be equivalent to a horizontal linear movement at a rate of about v=(5/0.5)*cos(90−20)=3.4 cm/sec, e.g., assuming the “hesitation” movements are at a tilt of about 20 degrees.

According to this example, processor 722 may be capable of identifying the “hesitation” movements of the detected person, for example, based on PC information including velocity information with a precision of 3.4 cm/sec or a better precision. For example, PC information including velocity information with a precision of 2 cm/sec, may be more than enough.

For example, processor 722 may determine the predicted behavior detection 725 to identify the predicted movement of the person about to cross the road, for example, based on identification of the “hesitation” movements of the detected person.

In some demonstrative aspects, processor 722 may be configured to determine a bounding box to bound the first element 752, for example, based on spatial locations of the plurality of first points corresponding to the first element 752, e.g., as described below.

In some demonstrative aspects, processor 722 may be configured to determine a bounding box to bound the second element 754, for example, based on spatial locations of the plurality of second points corresponding to the second element 754, e.g., as described below.

In some demonstrative aspects, processor 722 may be configured to control, instruct, and/or trigger output 726 to provide the output information 728 including bounding box information, for example, based on the bounding box corresponding to the first element 752 and/or the bounding box corresponding to the second element 754, e.g., as described below.

In some demonstrative aspects, processor 722 may be configured to identify the relative movement between the first element 752 and the second element 754 having a velocity of less than 10 cm/sec, e.g., as described below.

In some demonstrative aspects, processor 722 may be configured to identify the relative movement between the first element 752 and the second element 754 having a velocity of less than 7 cm/sec, e.g., as described below.

In some demonstrative aspects, processor 722 may be configured to identify the relative movement between the first element 752 and the second element 754 having a velocity of less than 5 cm/sec, e.g., as described below.

In some demonstrative aspects, processor 722 may be configured to identify the relative movement between the first element 752 and the second element 754 having a velocity of less than 3 cm/sec, e.g., as described below.

In some demonstrative aspects, processor 722 may be configured to identify the relative movement between the first element 752 and the second element 754 having a velocity of less than 2 cm/sec, e.g., as described below.

In other aspects, processor 722 may be configured to identify a relative movement of any other suitable velocity between the first element 752 and the second element 754.

In some demonstrative aspects, processor 722 may be configured to determine a first predicted behavior detection 725, for example, based on identification of a first relative movement between elements of a first detected target 750, e.g., as described below.

In some demonstrative aspects, processor 722 may be configured to determine a second predicted behavior detection 725, for example, based on identification of a second relative movement between elements of a second detected target 750, e.g., as described below.

In some demonstrative aspects, the first predicted behavior detection 725 corresponding to the first detected target 750 may be different from the second predicted behavior detection 725 corresponding to the second detected target 750, e.g., as described below.

In some demonstrative aspects, the first relative movement corresponding to the first detected target 750 may be different from the second relative movement corresponding to the second detected target 750, e.g., as described below.

In some demonstrative aspects, processor 722 may be configured to utilize the velocity information corresponding to the PC points of PC information 709, for example, to provide a technical solution to determine the predicted behavior detection 725 corresponding to the detected target 750, for example, even in case of a distant detected target 750, which is relatively far from the light-based sensor device 700, e.g., as described below.

In one example, a distant target may inherently suffer from a smaller set of data, e.g., pixels, points, detections or the like, which may be associated with the distant target in the PC information 709.

For example, an image-based implementation, e.g., using image sensors, may require a relatively large number of image frames, for example, in order to determine a direction of movement of a far target. Accordingly, such an image-based implementation may not be sufficient to provide real-time and/or reliable results, e.g., due to the time required for capturing the relatively large number of required image frames. For example, the image-based implementation may be capable of supporting detection of movement with a low granularity, for example, a general heading of a pedestrian or its limbs. For example, it may be difficult, or even impossible, for the image-based implementation to detect movement with high granularity and/or precision.

In some demonstrative aspects, processor 722 may be configured to utilize the velocity information corresponding to the PC points of PC information 709, for example, to provide a technical solution to identify movements with high granularity and/or precision, for example, even in case of a distant detected target 750, e.g., as described below.

In some demonstrative aspects, processor 722 may be configured to utilize the velocity information corresponding to the PC points of PC information 709, for example, to provide a technical solution to identify subtle movements of the detected target 750, e.g., movements of the head, movements of the shoulders, and/or any other subtle movements, and/or movements of small body parts, e.g., fingers.

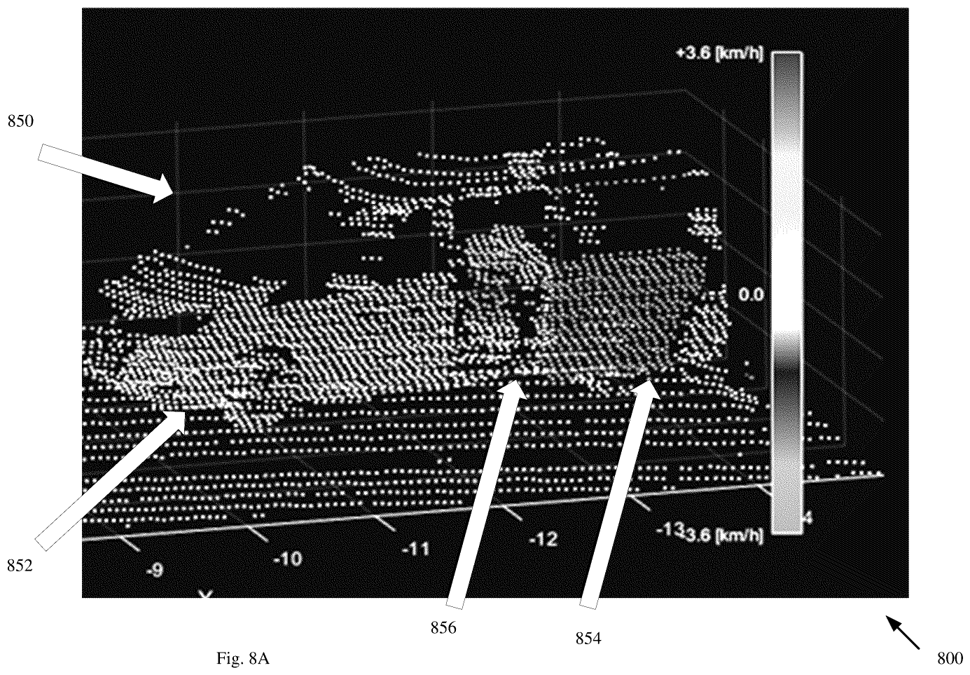

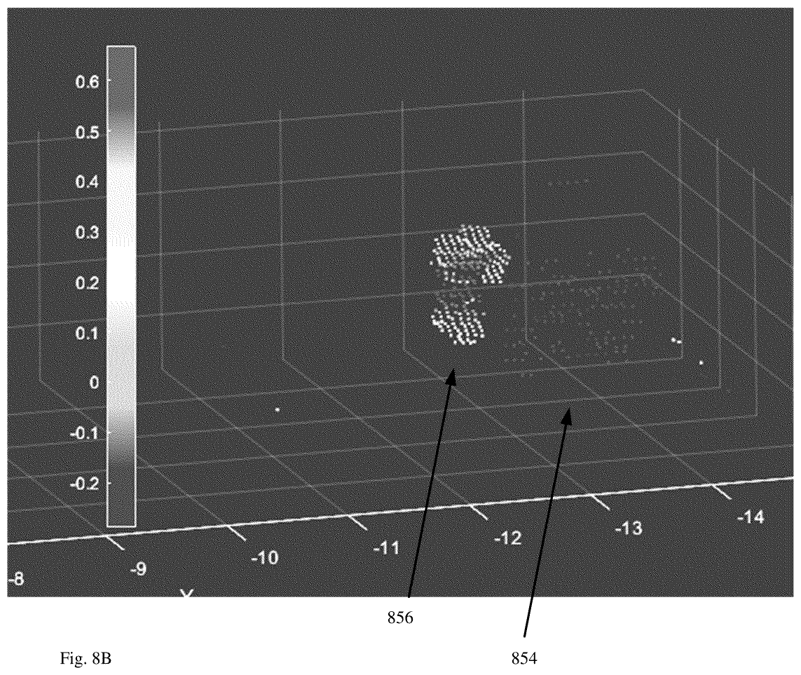

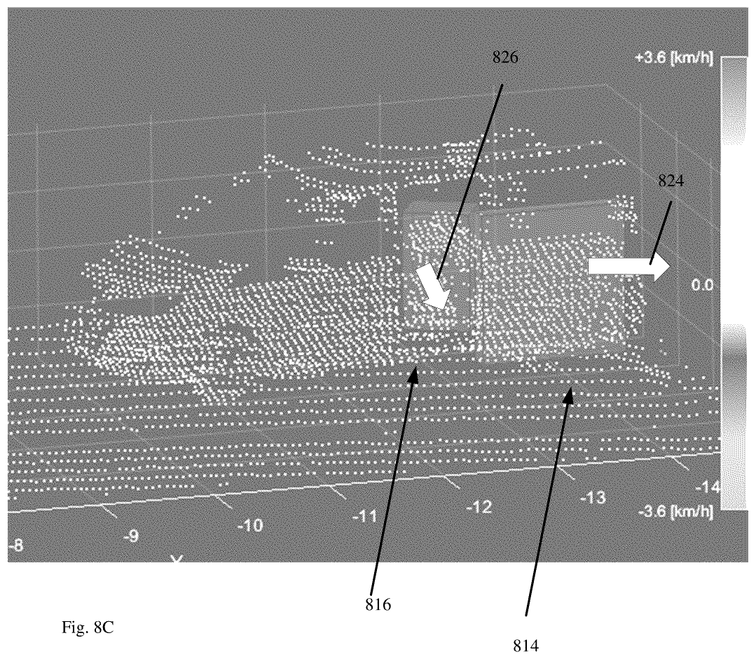

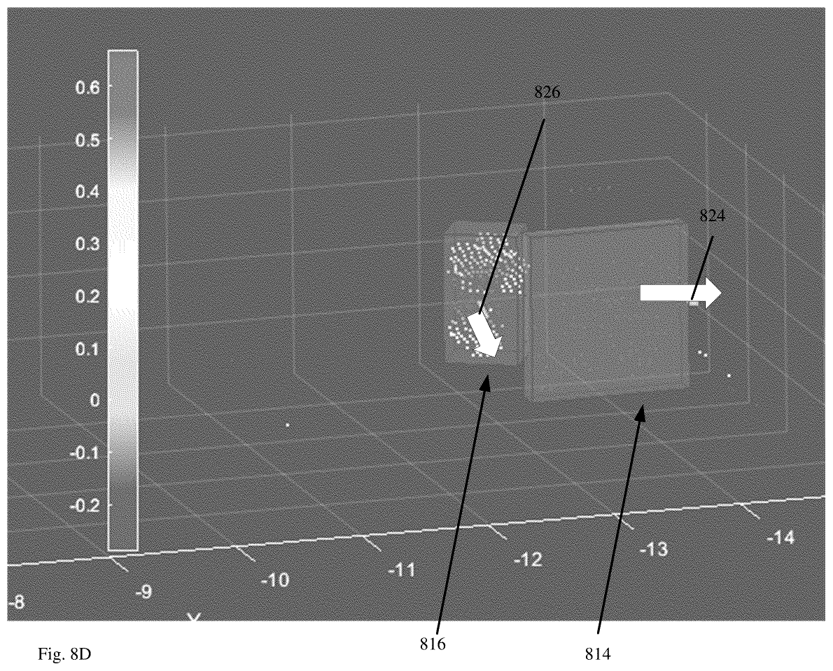

Reference is made to FIG. 8A, which schematically illustrates PC information of a PC frame 800, in accordance with some demonstrative aspects.

In some demonstrative aspects, as shown in FIG. 8A, PC frame 800 may include a plurality of points.

For example, the plurality of points in PC frame may correspond to a plurality of points scanned by an FMCW LiDAR device, e.g., LiDAR device 500 (FIG. 5), e.g., as described above.

In some demonstrative aspects, as shown in FIG. 8A, PC frame 800 may include a plurality of velocity values corresponding to the plurality of point in the PC frame 800.

In some demonstrative aspects, as shown in FIG. 8A, the plurality of velocity values may have a relatively high level of precision, for example, in a range between +−3.6 kilometer per hour (kmph), e.g., in a range between +−1 meter per sec (m/sec).

For example, a velocity value corresponding to a point may represent an estimated velocity corresponding to the point, e.g., based on a Doppler (micro Doppler) value detected by the FMCW LiDAR device.

In some demonstrative aspects, as shown in FIG. 8A, a detected target 850 may be detected based on the PC information of the PC frame 800.

In some demonstrative aspects, as shown in FIG. 8A, detected target 850 may include a detected vehicle 850, e.g., a van.

In some demonstrative aspects, as shown in FIG. 8A, a plurality of elements may be identified in the detected target 850, for example, based on the PC information of the PC frame 800.

In some demonstrative aspects, as shown in FIG. 8A, a first element 852, e.g., a body of detected vehicle 850, may be identified, for example, based on the PC information of the PC frame 800.

In some demonstrative aspects, as shown in FIG. 8A, the first element 852, e.g., the body of detected vehicle 850, may correspond to a plurality of first points in the PC frame 800.

In some demonstrative aspects, as shown in FIG. 8A, a first plurality of velocity values corresponding to the plurality of first points, e.g., corresponding to the first element 852, may be identified based on the PC information of the PC frame 800. For example, as shown in FIG. 8A, the first plurality of velocity values corresponding to the first element 852 may each have a velocity of about Ocm/sec.

For example, the first plurality of velocity values corresponding to the first element 852 may be based on first Doppler values, which may be detected by the FMCW LiDAR device, e.g., based on reflections from the body of the vehicle.

In some demonstrative aspects, as shown in FIG. 8A, a second element 854, e.g., a sliding door of the detected vehicle 850, may be identified, for example, based on the PC information of the PC frame 800.

In some demonstrative aspects, as shown in FIG. 8A, the second element 854, e.g., the sliding door of the detected vehicle 850, may correspond to a plurality of second points in the PC frame 800.

In some demonstrative aspects, as shown in FIG. 8A, a second plurality of velocity values corresponding to the plurality of second points, e.g., corresponding to the second element 854, may be identified based on the PC information of the PC frame 800. For example, as shown in FIG. 8A, the second plurality of velocity values corresponding to the second element 854 may each have a velocity of about 2 cm/sec.

For example, the second plurality of velocity values corresponding to the second element 854 may be based on second Doppler values, which may be detected by the FMCW LiDAR device, e.g., based on reflections from the sliding door of the vehicle.

In some demonstrative aspects, as shown in FIG. 8A, a third element 856, e.g., a human passenger in the detected vehicle 850, may be identified, for example, based on the PC information of the PC frame 800.

In some demonstrative aspects, as shown in FIG. 8A, the third element 856, e.g., the human passenger in the detected vehicle 850, may correspond to a plurality of third points in the PC frame 800.

In some demonstrative aspects, as shown in FIG. 8A, a third plurality of velocity values corresponding to the plurality of third points, e.g., corresponding to the third element 856, may be identified based on the PC information of the PC frame 800. For example, as shown in FIG. 8A, the third plurality of velocity values corresponding to the third element 856 may each have a velocity of about 3.5 cm/sec.

For example, the third plurality of velocity values corresponding to the third element 856 may be based on third Doppler values, which may be detected by the FMCW LiDAR device, e.g., based on reflections from the human passenger in the vehicle.

In some demonstrative aspects, a processor, e.g., processor 722 (FIG. 7), may be configured to identify a first relative movement between the body 852 of detected vehicle 850 and the sliding door 854 of detected vehicle 850.

In some demonstrative aspects, the processor, e.g., processor 722 (FIG. 7), may be configured to identify a second relative movement between the body 852 of detected vehicle 850 and the human passenger 856 inside the detected vehicle 850.

In some demonstrative aspects, the processor, e.g., processor 722 (FIG. 7), may determine a predicted behavior detection, for example, an exit of the human passenger 856 from the detected vehicle 850, for example, based on the first relative movement between the body 852 of detected vehicle 850 and the door 854 of detected vehicle 850, and/or based on the second relative movement between the body 852 of detected vehicle 850 and the human passenger 856.

In some demonstrative aspects, the processor, e.g., processor 722 (FIG. 7), may be configured to utilize the velocity (Doppler) information of PC frame 800, which may have a high precision level, e.g., of less than 2 cm/sec, for example, to provide a technical solution to predict the sliding of door 854, and/or the exiting of the human passenger 856 from the detected vehicle 850.

For example, as shown in FIG. 8A, it may be very hard, or even impossible, to clearly understand what is happening in the scene represented by the PC frame 800, for example, without the high precision velocity (Doppler) information.

For example, as shown in FIG. 8A, the processor, e.g., processor 722 (FIG. 7), may be configured to utilize the velocity (Doppler) information of PC frame 800, to predict the shift of the sliding door 854 of the detected vehicle 850, for example, based on a single PC frame, e.g., PC frame 800, for example, even before the sliding door 854 actually performs the action of sliding.

For example, as shown in FIG. 8A, the processor, e.g., processor 722 (FIG. 7), may be configured to utilize the velocity (Doppler) information of PC frame 800, to predict the motion of the human passenger 856 to exit the detected vehicle 850, for example, based on a single PC frame, e.g., PC frame 800, for example, even before the human passenger 856 actually performs the action of stepping out of the detected vehicle 850.

In some demonstrative aspects, a processor, e.g., processor 722 (FIG. 7), may be configured to segment and/or classify the plurality of points of PC frame 800, for example, based on the first plurality of velocity values corresponding to the vehicle body 852, the second plurality of velocity values corresponding to the sliding door 854, and/or the third plurality of velocity values corresponding to the human passenger 856.

Reference is made to FIG. 8B, which schematically illustrates segmentation based on the PC frame 800 (FIG. 8), in accordance with some demonstrative aspects.

In some demonstrative aspects, as shown in FIG. 8B, a processor, e.g., processor 722 (FIG. 7), may be configured to segment and/or classify the plurality of points of PC frame 800, for example, based on the first plurality of velocity values corresponding to the vehicle body 852, the second plurality of velocity values corresponding to the sliding door 854, and/or the third plurality of velocity values corresponding to the human passenger 856.

In some demonstrative aspects, as shown in FIG. 8B, the processor, e.g., processor 722 (FIG. 7), may be configured to segment and/or classify the plurality of points of detected vehicle 850, for example, to identify the plurality of second points corresponding to the sliding door 854, for example, based on identifying the difference in the second plurality of velocity values corresponding to the plurality of second points of the sliding door 854, e.g., relative to the first plurality of velocity values corresponding to the plurality of first points of the vehicle body 852.

In some demonstrative aspects, as shown in FIG. 8B, the processor, e.g., processor 722 (FIG. 7), may be configured to segment and/or classify the plurality of points of detected vehicle 850, for example, to identify the plurality of third points corresponding to the human passenger 856, for example, based on identifying the difference in the third plurality of velocity values corresponding to the plurality of third points of the human passenger 856, e.g., relative to the first plurality of velocity values corresponding to the plurality of first points of the vehicle body 852.

In some demonstrative aspects, as shown in FIG. 8B, the processor, e.g., processor 722 (FIG. 7), may be configured to segment and/or classify the plurality of points of detected vehicle 850, for example, to identify the sliding door 854 and/or the human passenger 856, for example, based on a single PC frame 800, e.g., based on the high-precision velocity (Doppler) information of the PC frame 800.

In some demonstrative aspects, the processor, e.g., processor 722 (FIG. 7), may be configured to determine a bounding box to bound the sliding door 854, and/or a bounding box to bound the human passenger 856, e.g., as described below.

Reference is made to FIG. 8C, which schematically illustrates processed PC information based on the PC frame 800, in accordance with some demonstrative aspects.

In some demonstrative aspects, as shown in FIG. 8C, a processor, e.g., processor 722 (FIG. 7), may be configured to determine a bounding box 814 to bound the sliding door 854.

In some demonstrative aspects, as shown in FIG. 8C, the processor, e.g., processor 722 (FIG. 7), may be configured to determine the bounding box 814 to bound the sliding door 854, for example, based on spatial locations of the plurality of second points having the second plurality of velocity (Doppler) values, e.g., which may be different from the velocity (Doppler) values of the points corresponding to the body 852 of the vehicle 858.

In some demonstrative aspects, as shown in FIG. 8C, the processor, e.g., processor 722 (FIG. 7), may be configured to determine a bounding box 816 to bound the human passenger 856.

In some demonstrative aspects, as shown in FIG. 8C, the processor, e.g., processor 722 (FIG. 7), may be configured to determine the bounding box 816 to bound the human passenger 856, for example, based on spatial locations of the plurality of third points having the third plurality of velocity (Doppler) values, e.g., which may be different from the velocity (Doppler) values of the points corresponding to the vehicle body 852 of the vehicle 850.

In some demonstrative aspects, the processor, e.g., processor 722 (FIG. 7), may be configured to determine a predicted heading, e.g., a predicted direction, of a moving element, for example, based on velocity information of a plurality of points corresponding to the element.

In some demonstrative aspects, as shown in FIG. 8C, the processor, e.g., processor 722 (FIG. 7), may be configured to determine a direction of movement 824 of the sliding door 854 (FIG. 8A), for example, based on the second plurality of velocity values corresponding to the plurality of second points of the sliding door 854 (FIG. 8A).

In some demonstrative aspects, as shown in FIG. 8C, the processor, e.g., processor 722 (FIG. 7), may be configured to determine a direction of movement 826 of the human passenger 856, for example, based on the third plurality of velocity values corresponding to the plurality of third points of the human 856.

In some demonstrative aspects, the processor, e.g., processor 722 (FIG. 7), may be configured to segment and classify a detected target, to determine a heading, e.g., a direction, of one or more elements of the detected target, and/or to determine a bounding box of the one or more elements, for example, based on PC information of a single PC frame 800, e.g., as described below.

Reference is made to FIG. 8D, which schematically illustrates processed point cloud information based on PC frame 800, in accordance with some demonstrative aspects.

In some demonstrative aspects, as shown in FIG. 8D, a processor, e.g., processor 722 (FIG. 7), may be configured to segment the plurality of points of PC frame 800, and to determine the direction 824 and the bounding box 814 corresponding to the sliding door 854, for example, based on a single PC frame, e.g., PC frame 800.

In some demonstrative aspects, as shown in FIG. 8D, the processor, e.g., processor 722 (FIG. 7), may be configured to segment the plurality of points of PC frame 800, and to determine the direction 826 and the bounding box 816 of the human passenger 856, for example, based on a single PC frame, e.g., PC frame 800.

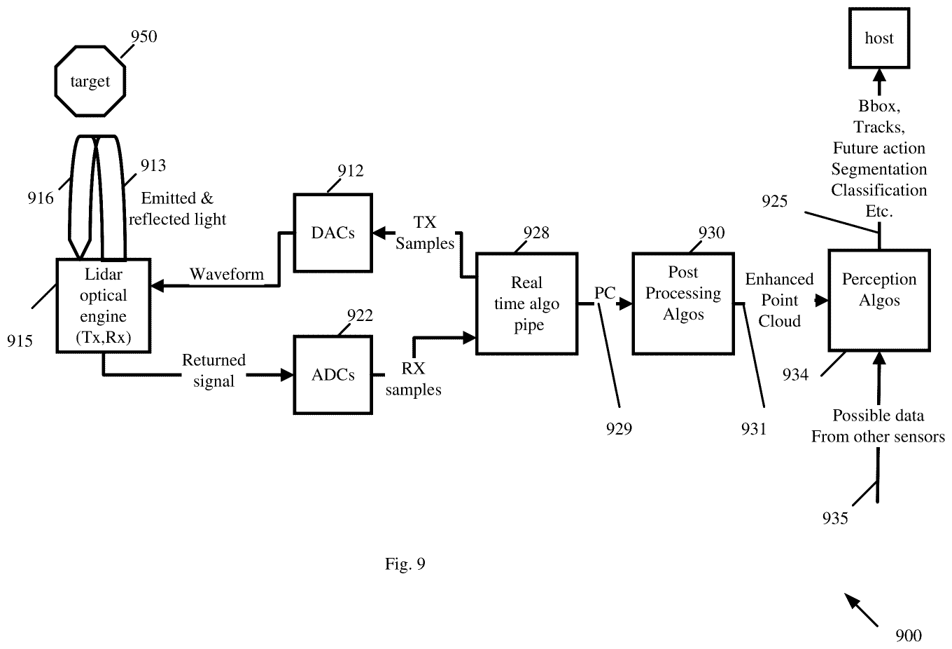

Reference is made to FIG. 9, which schematically illustrates a block diagram of a system 900, in accordance with some demonstrative aspects.

For example, light-based sensor device 700 (FIG. 7) may include one or more of the elements of system 900, and/or may perform one or more operations of system 900.

In some demonstrative aspects, as shown in FIG. 9, system 900 may include one or more DACs 912, which may be configured to modulate Tx samples to emit laser light 913 towards a target 950, e.g., after applying a gain to the laser light 913.

In some demonstrative aspects, as shown in FIG. 9, system 900 may include a Tx/Rx interface 915, which may be configured to emit the laser light 913, and to receive reflected light 916 of the laser light 913, e.g., reflected from the target 950.

In some demonstrative aspects, the reflected light 916 may be converted into an electrical current, for example, by a balanced photo diode, e.g., as described above.

In some demonstrative aspects, the electrical current may be amplified and translated into a voltage signal, for example, by a trans impedance amplifier.

In some demonstrative aspects, as shown in FIG. 9, system 900 may include one or more ADCs 922, which may be configured to sample the voltage signal and provide Rx samples.

In some demonstrative aspects, as shown in FIG. 9, system 900 may include a processor 928, which may be configured to process the Rx samples and to output PC information 929.

In one example, PC information 929 may include a plurality of points in a suitable coordinate system, e.g., a Cartesian coordinate system, a polar coordinate system, or the like. For example, the PC information 929 may include intensity information including intensity values corresponding to the plurality of points.

In some demonstrative aspects, PC information 929 may include velocity (Doppler) information corresponding to the plurality of points, for example, in an FMCW LiDAR implementation, e.g., in addition to the plurality of points and the intensity information.

In some demonstrative aspects, the PC information 929 may include Doppler information with high precision (“micro Doppler information”), which may be configured, for example, to support estimation of future actions of road users, e.g., humans, as described above.

In one example, processor 928 may include, for example, dedicated real time Hardware (HW), which may be implemented, for example, by one or more Application Specific Integrated Circuits (ASICs), one or more Field Programmable Gate Arrays (FPGAs), and/or any other additional or alternative digital processing units.

In some demonstrative aspects, as shown in FIG. 9, system 900 may include an enhancer 930, which may include one or more post-processing enhancement algorithms.

For example, the post-processing enhancement algorithms may be utilized, for example, for error reduction, and/or the like.

For example, the post-processing enhancement algorithms may be implemented, for example, in Software (SW).

In some demonstrative aspects, as shown in FIG. 9, enhancer 930, may be configured to generate enhanced PC information 931.

In some demonstrative aspects, as shown in FIG. 9, system 900 may include one or more perception algorithms 934, which may be configured to process the PC information 929, or the enhanced PC information 931, e.g., if implemented.

In some demonstrative aspects, the one or more perception algorithms 934 may be utilized, for example, to detect objects and/or road users in a scene, to classify the objects into different classes, to track their motion, to predict their future action, and/or to perform any other analysis, estimation and/or prediction.

In some demonstrative aspects, processor 722 (FIG. 7) may implement one or more perception algorithms 934, for example, to determine a predicted behavior detection 925 corresponding to the target 950.

For example, processor 722 (FIG. 7) may implement the one or more perception algorithms 934, for example, to determine the predicted behavior detection 725 (FIG. 7) corresponding to the detected target 750 (FIG. 7), for example, based on the PC information 709 (FIG. 7), e.g., as described above.

In some demonstrative aspects, as shown in FIG. 9, the predicted behavior detection 925 may include a bounding box of the target 950, a future track of the target 950, a future action of the target 950, segmentation and/or classification information of the target 950, and/or any other additional or alternative information with respect to the target 950.

In some demonstrative aspects, the one or more perception algorithms 934 may optionally use data 935 from additional sensors, e.g., image-based sensors, radar sensors, or the like, for example, to determine the predicted behavior detection 925.

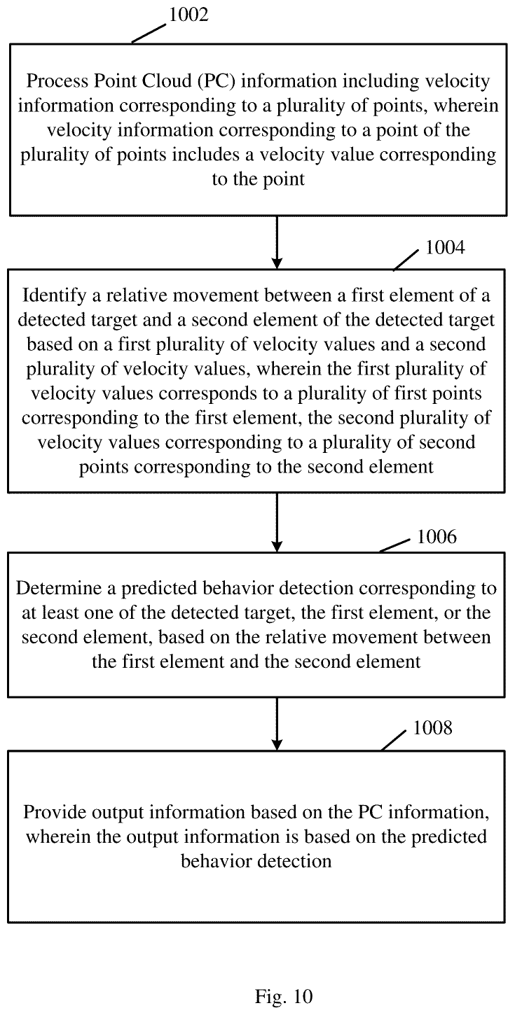

Reference is made to FIG. 10, which schematically illustrates a method of determining a predicted behavior detection based on PC information. For example, one or more of the operations of the method of FIG. 10 may be performed by a light-based sensor device, e.g., light-based sensor device 700 (FIG. 7), and/or a processor, e.g., data processor 720 (FIG. 7), and/or processor 722 (FIG. 7).

As indicated at block 1002, the method may include processing PC information including velocity information corresponding to a plurality of points. For example, velocity information corresponding to a point of the plurality of points may include a velocity value corresponding to the point. For example, data processor 720 (FIG. 7) may be configured to process PC information 709 (FIG. 7) including the velocity information corresponding to the plurality of points, e.g., as described above.

As indicated at block 1004, the method may include identifying a relative movement between a first element of a detected target and a second element of the detected target, for example, based on a first plurality of velocity values and a second plurality of velocity values. For example, the first plurality of velocity values may correspond to a plurality of first points corresponding to the first element, and the second plurality of velocity values may correspond to a plurality of second points corresponding to the second element. For example, processor 722 (FIG. 7) may be configured to identify the relative movement between the first element 752 (FIG. 7) of the detected target 750 (FIG. 7) and the second element 754 (FIG. 7) of the detected target 750 (FIG. 7), for example, based on the first plurality of velocity values corresponding to points of the first element 752 (FIG. 7), and the second plurality of velocity values corresponding to points of second first element 754 (FIG. 7), e.g., as described above.

As indicated at block 1006, the method may include determining a predicted behavior detection corresponding to at least one of the detected target, the first element, or the second element, for example, based on the relative movement between the first element and the second element. For example, processor 722 (FIG. 7) may be configured to determine the predicted behavior detection 725 (FIG. 7) corresponding to the detected target 750 (FIG. 7), the first element 752 (FIG. 7), and/or the second element 754 (FIG. 7), for example, based on the relative movement between the first element 752 (FIG. 7) and the second element 754 (FIG. 7), e.g., as described above.

As indicated at block 1008, the method may include providing output information based on the PC information. For example, the output information may be based on the predicted behavior detection. For example, processor 722 (FIG. 7) may be configured to provide output information 728 (FIG. 7), for example, via output 726 (FIG. 7), for example, based on the predicted behavior detection 725 (FIG. 7), e.g., as described above.

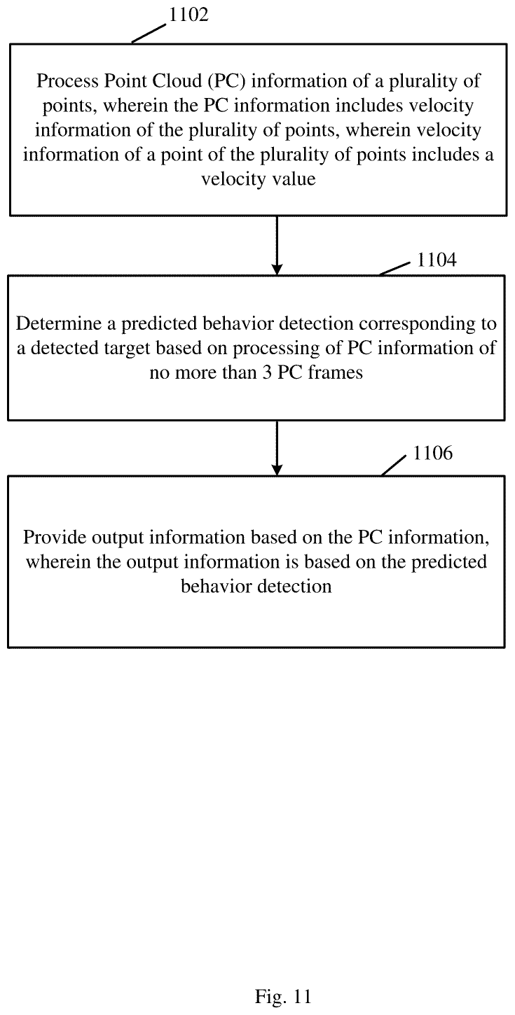

Reference is made to FIG. 11, which schematically illustrates a method of determining a predicted behavior detection based on PC information. For example, one or more of the operations of the method of FIG. 11 may be performed by a light-based sensor device, e.g., light-based sensor device 700 (FIG. 7), and/or a processor, e.g., data processor 720 (FIG. 7), and/or processor 722 (FIG. 7).

As indicated at block 1102, the method may include processing PC information of a plurality of points. For example, the PC information may include velocity information of the plurality of points. For example, velocity information of a point of the plurality of points may include a velocity value. For example, data processor 720 (FIG. 7) may be configured to process PC information 709 (FIG. 7) of the plurality of points, e.g., as described above.

As indicated at block 1104, the method may include determining a predicted behavior detection corresponding to a detected target based on processing of PC information of no more than 3 PC frames. For example, processor 722 (FIG. 7) may be configured to determine the predicted behavior detection 725 (FIG. 7) corresponding to the detected target 750 (FIG. 7), for example, based on processing of PC information 709 (FIG. 7) of no more than 3 PC frames, e.g., as described above.

As indicated at block 1108, the method may include providing output information based on the PC information. For example, the output information may be based on the predicted behavior detection. For example, processor 722 (FIG. 7) may be configured to provide output information 728 (FIG. 7), for example, via output 726 (FIG. 7), for example, based on the predicted behavior detection 725 (FIG. 7), e.g., as described above.

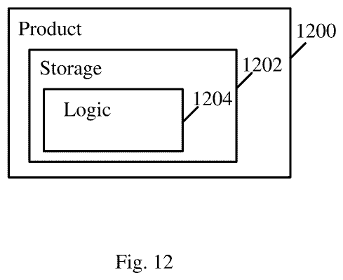

Reference is made to FIG. 12, which schematically illustrates a product of manufacture 1200, in accordance with some exemplary aspects. Product 1200 may include one or more tangible computer-readable (“machine-readable”) non-transitory storage media 1202, which may include computer-executable instructions, e.g., implemented by logic 1204, operable to, when executed by at least one computer processor, enable the at least one computer processor to implement one or more operations at a light-based sensor device, e.g., light-based sensor device 101 (FIG. 1), light-based sensor device 300 (FIG. 3), light-based sensor device 211 (FIG. 2), light-based sensor device 400 (FIG. 4), light-based sensor device 500 (FIG. 5), and/or light-based sensor device 700 (FIG. 7), a processor and/or a controller, e.g., data processor 720 (FIG. 7), and/or processor 722 (FIG. 7); to cause a light-based sensor device, e.g., light-based sensor device 101 (FIG. 1), light-based sensor device 300 (FIG. 3), light-based sensor device 211 (FIG. 2), light-based sensor device 400 (FIG. 4), light-based sensor device 500 (FIG. 5), and/or light-based sensor device 1100 (FIG. 11), and/or light-based sensor device 700 (FIG. 7), and/or a processor and/or a controller, e.g., data processor 720 (FIG. 7), and/or processor 722 (FIG. 7), to perform, trigger and/or implement one or more operations and/or functionalities; and/or to perform, trigger and/or implement one or more operations and/or functionalities described with reference to the FIGS. 1-11, and/or one or more operations described herein. The phrases “non-transitory machine-readable medium” and “computer-readable non-transitory storage media” may be directed to include all computer-readable media, with the sole exception being a transitory propagating signal.

In some demonstrative aspects, product 1200 and/or machine-readable storage media 1202 may include one or more types of computer-readable storage media capable of storing data, including volatile memory, non-volatile memory, removable or non-removable memory, erasable or non-erasable memory, writeable or re-writeable memory, and the like. For example, machine-readable storage media 1202 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a Solid State Drive (SSD), a disk, a drive, and the like. The computer-readable storage media may include any suitable media involved with downloading or transferring a computer program from a remote computer to a requesting computer carried by data signals embodied in a carrier wave or other propagation medium through a communication link, e.g., a modem, radio, or network connection.

In some demonstrative aspects, logic 1204 may include instructions, data, and/or code, which, if executed by a machine, may cause the machine to perform a method, process, and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 1204 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner, or syntax, for instructing a processor to perform a certain function. The instructions may be implemented using any suitable high-level, low-level, object-oriented, visual, compiled and/or interpreted programming language.

### Examples

The following examples pertain to further aspects.

Example 1 includes an apparatus comprising a processor configured to process Point Cloud (PC) information comprising velocity information corresponding to a plurality of points, wherein velocity information corresponding to a point of the plurality of points comprises a velocity value corresponding to the point, the processor configured to identify a relative movement between a first element of a detected target and a second element of the detected target based on a first plurality of velocity values and a second plurality of velocity values, wherein the first plurality of velocity values corresponds to a plurality of first points corresponding to the first element, the second plurality of velocity values corresponding to a plurality of second points corresponding to the second element; and determine a predicted behavior detection corresponding to at least one of the detected target, the first element, or the second element, based on the relative movement between the first element and the second element; and an output to provide output information based on the PC information, wherein the output information is based on the predicted behavior detection.

Example 2 includes the subject matter of Example 1, and optionally, wherein the processor is configured to determine a first movement vector corresponding to the first element based on the first plurality of velocity values, to determine a second movement vector corresponding to the second element based on the second plurality of velocity values, and to determine the relative movement between the first element and the second element based on the first movement vector and the second movement vector.

Example 3 includes the subject matter of Example 2, and optionally, wherein the processor is configured to determine a direction of the relative movement between the first element and the second element based on a direction of the first movement vector and a direction of the second movement vector, and to determine the predicted behavior detection based on the direction of the relative movement between the first element and the second element.

Example 4 includes the subject matter of Example 2 or 3, and optionally, wherein the processor is configured to determine a magnitude of the relative movement between the first element and the second element based on a magnitude of the first movement vector and a magnitude of the second movement vector, and to determine the predicted behavior detection based on the magnitude of the relative movement between the first element and the second element.

Example 5 includes the subject matter of any one of Examples 1-4, and optionally, wherein the processor is configured to determine the predicted behavior detection based on a direction of the relative movement between the first element and the second element.

Example 6 includes the subject matter of any one of Examples 1-5, and optionally, wherein the processor is configured to determine a predicted angular movement of the detected target based on the relative movement between the first element and the second element, and to determine the predicted behavior detection based on the predicted angular movement of the detected target.

Example 7 includes the subject matter of Example 6, and optionally, wherein the processor is configured to determine the predicted angular movement of the detected target based on identification of a first relative movement and a second relative movement, the first relative movement is between the first element of the detected target and the second element of the detected target, the second relative movement is between a third element of the detected target and the second element of the detected target.

Example 8 includes the subject matter of Example 7, and optionally, wherein the processor is configured to determine the predicted angular movement of the detected target based on identification that the first relative movement is in a direction substantially opposite to a direction of the second relative movement.

Example 9 includes the subject matter of any one of Examples 1-8, and optionally, wherein the processor is configured to determine a first predicted behavior detection based on identification of a first relative movement between elements of a first detected target, and to determine a second predicted behavior detection based on identification of a second relative movement between elements of a second detected target, wherein the first predicted behavior detection is different from the second predicted behavior detection, and the first relative movement is different from the second relative movement.

Example 10 includes the subject matter of any one of Examples 1-9, and optionally, wherein the processor is configured to determine a direction of the relative movement between the first element and the second element based on the first plurality of velocity values and the second plurality of velocity values, and to determine the predicted behavior detection based on the direction of the relative movement between the first element and the second element.

Example 11 includes the subject matter of any one of Examples 1-10, and optionally, wherein the processor is configured to determine a bounding box to bound the first element based on spatial locations of the plurality of first points, wherein the output information comprises bounding box information based on the bounding box.

Example 12 includes the subject matter of any one of Examples 1-11, and optionally, wherein the processor is configured to determine the predicted behavior detection based on processing of PC information of no more than 3 PC frames.

Example 13 includes the subject matter of any one of Examples 1-12, and optionally, wherein the processor is configured to determine the predicted behavior detection based on processing of PC information of a single PC frame.

Example 14 includes the subject matter of any one of Examples 1-13, and optionally, wherein the processor is configured to identify the relative movement between the first element and the second element having a velocity of less than 10 centimeter (cm) per second (sec) (cm/sec).

Example 15 includes the subject matter of any one of Examples 1-14, and optionally, wherein the processor is configured to identify the relative movement between the first element and the second element having a velocity of less than 7 centimeter (cm) per second (sec) (cm/sec).

Example 16 includes the subject matter of any one of Examples 1-15, and optionally, wherein the processor is configured to identify the relative movement between the first element and the second element having a velocity of less than 3 centimeter (cm) per second (sec) (cm/sec).

Example 17 includes the subject matter of any one of Examples 1-16, and optionally, wherein the predicted behavior detection comprises a predicted behavior detection corresponding to the detected target.

Example 18 includes the subject matter of Example 17, and optionally, wherein the predicted behavior detection corresponding to the detected target comprises a predicted movement of the detected target.

Example 19 includes the subject matter of Example 18, and optionally, wherein the predicted movement of the detected target comprises a change in a direction of movement of the detected target.

Example 20 includes the subject matter of Example 18, and optionally, wherein the predicted movement of the detected target comprises a start of movement of the detected target.

Example 21 includes the subject matter of any one of Examples 1-20, and optionally, wherein the predicted behavior detection comprises a predicted behavior detection corresponding to at least one element of the first element of the detected target or the second element of the detected target.

Example 22 includes the subject matter of Example 21, and optionally, wherein the predicted behavior detection corresponding to the at least one element comprises a predicted movement of the at least one element relative to the detected target.

Example 23 includes the subject matter of any one of Examples 1-22, and optionally, wherein the detected target comprises a human, the first element comprising a first body part of the human, the second element comprising a second body part of the human.

Example 24 includes the subject matter of any one of Examples 1-22, and optionally, wherein the detected target comprises a vehicle, the first element comprising a first part of the vehicle, the second element comprising a second part of the vehicle.

Example 25 includes the subject matter of any one of Examples 1-22, and optionally, wherein the detected target comprises a vehicle, the first element comprising a part of the vehicle, the second element comprising a human inside the vehicle.

Example 26 includes the subject matter of any one of Examples 1-25, and optionally, wherein the PC information comprises Light Detection and Ranging (LiDAR) PC information.

Example 27 includes the subject matter of Example 26, and optionally, wherein the LiDAR PC information comprises Frequency Modulated Continuous Wave (FMCW) LiDAR PC information of an FMCW LIDAR.

Example 28 includes the subject matter of any one of Examples 1-27, and optionally, comprising a Light Detection and Ranging (LiDAR) device comprising a LiDAR transmitter configured to emit laser light comprising a plurality of LiDAR transmit signals; a LiDAR receiver configured to detect reflected laser light based on the plurality of LiDAR transmit signals; and a LiDAR processor to generate the PC information.

Example 29 includes the subject matter of any one of Examples 1-28, and optionally, comprising a vehicle, the vehicle comprising a system controller to control one or more systems of the vehicle based on target information, the target information based on the output information.

Example 30 includes an apparatus comprising a processor configured to process Point Cloud (PC) information of a plurality of points, wherein the PC information comprises velocity information of the plurality of points, wherein velocity information of a point of the plurality of points comprises a velocity value, the processor configured to determine a predicted behavior detection corresponding to a detected target based on processing of PC information of no more than 3 PC frames; and an output to provide output information based on the PC information, wherein the output information is based on the predicted behavior detection.

Example 31 includes the subject matter of Example 30, and optionally, wherein the processor is configured to determine the predicted behavior detection based on processing of PC information of no more than 2 PC frames.

Example 32 includes the subject matter of Example 30 or 31, and optionally, wherein the processor is configured to determine the predicted behavior detection based on processing of PC information of a single PC frame.

Example 33 includes the subject matter of any one of Examples 30-32, and optionally, wherein the processor is configured to determine a relative movement between a first element of the detected target and a second element of the detected target based on the PC information, and to determine the predicted behavior detection based on the relative movement between the first element and the second element.

Example 34 includes the subject matter of Example 33, and optionally, wherein the processor is configured to determine a first movement vector corresponding to the first element based on a first plurality of velocity values corresponding to a plurality of first points corresponding to the first element, to determine a second movement vector corresponding to the second element based on a second plurality of velocity values corresponding to a plurality of second points corresponding to the second element, and to determine the relative movement between the first element and the second element based on the first movement vector and the second movement vector.

Example 35 includes the subject matter of Example 34, and optionally, wherein the processor is configured to determine a direction of the relative movement between the first element and the second element based on a direction of the first movement vector and a direction of the second movement vector, and to determine the predicted behavior detection based on the direction of the relative movement between the first element and the second element.

Example 36 includes the subject matter of Example 34 or 35, and optionally, wherein the processor is configured to determine a magnitude of the relative movement between the first element and the second element based on a magnitude of the first movement vector and a magnitude of the second movement vector, and to determine the predicted behavior detection based on the magnitude of the relative movement between the first element and the second element.

Example 37 includes the subject matter of any one of Examples 33-36, and optionally, wherein the processor is configured to determine the predicted behavior detection based on a direction of the relative movement between the first element and the second element.

Example 38 includes the subject matter of any one of Examples 33-37, and optionally, wherein the processor is configured to determine a predicted angular movement of the detected target based on the relative movement between the first element and the second element, and to determine the predicted behavior detection based on the predicted angular movement of the detected target.

Example 39 includes the subject matter of Example 38, and optionally, wherein the processor is configured to determine the predicted angular movement of the detected target based on identification of a first relative movement and a second relative movement, the first relative movement is between the first element of the detected target and the second element of the detected target, the second relative movement is between a third element of the detected target and the second element of the detected target.

Example 40 includes the subject matter of Example 39, and optionally, wherein the processor is configured to determine the predicted angular movement of the detected target based on identification that the first relative movement is in a direction substantially opposite to a direction of the second relative movement.

Example 41 includes the subject matter of any one of Examples 33-40, and optionally, wherein the processor is configured to determine a first predicted behavior detection based on identification of a first relative movement between elements of a first detected target, and to determine a second predicted behavior detection based on identification of a second relative movement between elements of a second detected target, wherein the first predicted behavior detection is different from the second predicted behavior detection, and the first relative movement is different from the second relative movement.

Example 42 includes the subject matter of any one of Examples 33-41, and optionally, wherein the processor is configured to determine a direction of the relative movement between the first element and the second element based on the first plurality of velocity values and the second plurality of velocity values, and to determine the predicted behavior detection based on the direction of the relative movement between the first element and the second element.

Example 43 includes the subject matter of any one of Examples 33-42, and optionally, wherein the processor is configured to determine a bounding box to bound the first element based on spatial locations of a plurality of points corresponding to the first element, wherein the output information comprises bounding box information based on the bounding box.

Example 44 includes the subject matter of any one of Examples 33-43, and optionally, wherein the processor is configured to identify the relative movement between the first element and the second element having a velocity of less than 10 centimeter (cm) per second (sec) (cm/sec).

Example 45 includes the subject matter of any one of Examples 33-44, and optionally, wherein the processor is configured to identify the relative movement between the first element and the second element having a velocity of less than 7 centimeter (cm) per second (sec) (cm/sec).

Example 46 includes the subject matter of any one of Examples 33-45, and optionally, wherein the processor is configured to identify the relative movement between the first element and the second element having a velocity of less than 3 centimeter (cm) per second (sec) (cm/sec).

Example 47 includes the subject matter of any one of Examples 33-46, and optionally, wherein the detected target comprises a human, the first element comprising a first body part of the human, the second element comprising a second body part of the human.

Example 48 includes the subject matter of any one of Examples 33-46, and optionally, wherein the detected target comprises a vehicle, the first element comprising a first part of the vehicle, the second element comprising a second part of the vehicle.

Example 49 includes the subject matter of any one of Examples 33-46, and optionally, wherein the detected target comprises a vehicle, the first element comprising a part of the vehicle, the second element comprising a human inside the vehicle.

Example 50 includes the subject matter of any one of Examples 30-49, and optionally, wherein the predicted behavior detection comprises a predicted movement of the detected target.

Example 51 includes the subject matter of Example 50, and optionally, wherein the predicted movement of the detected target comprises a change in a direction of movement of the detected target.

Example 52 includes the subject matter of Example 50, and optionally, wherein the predicted movement of the detected target comprises a start of movement of the detected target.

Example 53 includes the subject matter of any one of Examples 30-49, and optionally, wherein the predicted behavior detection comprises a predicted behavior of at least one element of the detected target.

Example 54 includes the subject matter of Example 53, and optionally, wherein the predicted behavior of the at least one element comprises a predicted movement of the at least one element relative to the detected target.

Example 55 includes the subject matter of any one of Examples 30-54, and optionally, wherein the PC information comprises Light Detection and Ranging (LiDAR) PC information.

Example 56 includes the subject matter of Example 55, and optionally, wherein the LiDAR PC information comprises Frequency Modulated Continuous Wave (FMCW) LiDAR PC information of an FMCW LIDAR.

Example 57 includes the subject matter of any one of Examples 30-56, and optionally, comprising a Light Detection and Ranging (LiDAR) device comprising a LiDAR transmitter configured to emit laser light comprising a plurality of LiDAR transmit signals; a LiDAR receiver configured to detect reflected laser light based on the plurality of LiDAR transmit signals; and a LiDAR processor to generate the PC information.

Example 58 includes the subject matter of any one of Examples 30-57, and optionally, comprising a vehicle, the vehicle comprising a system controller to control one or more systems of the vehicle based on target information, the target information based on the output information.

Example 59 includes a Light Detection and Ranging (LiDAR) system comprising the subject matter of any of Examples 1-58.

Example 60 includes a vehicle comprising the subject matter of any of Examples 1-58.

Example 61 includes an apparatus comprising means for performing any of the described operations of any of Examples 1-58.

Example 62 includes a machine-readable medium that stores instructions for execution by a processor to perform any of the described operations of any of Examples 1-58.

Example 63 comprises a product comprising one or more tangible computer-readable non-transitory storage media comprising instructions operable to, when executed by at least one processor, enable the at least one processor to cause a device and/or system to perform any of the described operations of any of Examples 1-58.

Example 64 includes an apparatus comprising a memory; and processing circuitry configured to perform any of the described operations of any of Examples 1-58.

Example 65 includes a method including any of the described operations of any of Examples 1-58.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to process Point Cloud (PC) information comprising velocity information corresponding to a plurality of points, wherein velocity information corresponding to a point of the plurality of points comprises a velocity value corresponding to the point, the processor configured to:
identify a relative movement between a first element of a detected target and a second element of the detected target based on a first plurality of velocity values and a second plurality of velocity values, wherein the first plurality of velocity values corresponds to a plurality of first points corresponding to the first element, the second plurality of velocity values corresponding to a plurality of second points corresponding to the second element; and
determine a predicted behavior detection corresponding to at least one of the detected target, the first element, or the second element, based on the relative movement between the first element and the second element; and
an output to provide output information based on the PC information, wherein the output information is based on the predicted behavior detection.

2. The apparatus of claim 1, wherein the processor is configured to determine a first movement vector corresponding to the first element based on the first plurality of velocity values, to determine a second movement vector corresponding to the second element based on the second plurality of velocity values, and to determine the relative movement between the first element and the second element based on the first movement vector and the second movement vector.

3. The apparatus of claim 2, wherein the processor is configured to determine a direction of the relative movement between the first element and the second element based on a direction of the first movement vector and a direction of the second movement vector, and to determine the predicted behavior detection based on the direction of the relative movement between the first element and the second element.

4. The apparatus of claim 2, wherein the processor is configured to determine a magnitude of the relative movement between the first element and the second element based on a magnitude of the first movement vector and a magnitude of the second movement vector, and to determine the predicted behavior detection based on the magnitude of the relative movement between the first element and the second element.

5. The apparatus of claim 1, wherein the processor is configured to determine the predicted behavior detection based on a direction of the relative movement between the first element and the second element.

6. The apparatus of claim 1, wherein the processor is configured to determine a predicted angular movement of the detected target based on the relative movement between the first element and the second element, and to determine the predicted behavior detection based on the predicted angular movement of the detected target.

7. The apparatus of claim 6, wherein the processor is configured to determine the predicted angular movement of the detected target based on identification of a first relative movement and a second relative movement, the first relative movement is between the first element of the detected target and the second element of the detected target, the second relative movement is between a third element of the detected target and the second element of the detected target.

8. The apparatus of claim 7, wherein the processor is configured to determine the predicted angular movement of the detected target based on identification that the first relative movement is in a direction substantially opposite to a direction of the second relative movement.

9. The apparatus of claim 1, wherein the processor is configured to determine a first predicted behavior detection based on identification of a first relative movement between elements of a first detected target, and to determine a second predicted behavior detection based on identification of a second relative movement between elements of a second detected target, wherein the first predicted behavior detection is different from the second predicted behavior detection, and the first relative movement is different from the second relative movement.

10. The apparatus of claim 1, wherein the processor is configured to determine a direction of the relative movement between the first element and the second element based on the first plurality of velocity values and the second plurality of velocity values, and to determine the predicted behavior detection based on the direction of the relative movement between the first element and the second element.

11. The apparatus of claim 1, wherein the processor is configured to determine the predicted behavior detection based on processing of PC information of no more than 3 PC frames.

12. The apparatus of claim 1, wherein the processor is configured to determine the predicted behavior detection based on processing of PC information of a single PC frame.

13. The apparatus of claim 1, wherein the processor is configured to identify the relative movement between the first element and the second element having a velocity of less than 10 centimeter (cm) per second (sec) (cm/sec).

14. The apparatus of claim 1, wherein the predicted behavior detection comprises a predicted behavior detection corresponding to the detected target.

15. The apparatus of claim 1, wherein the predicted behavior detection comprises a predicted behavior detection corresponding to at least one element of the first element of the detected target or the second element of the detected target.

16. The apparatus of claim 1, wherein the detected target comprises a human, the first element comprising a first body part of the human, the second element comprising a second body part of the human.

17. The apparatus of claim 1, wherein the detected target comprises a vehicle, the first element comprising a first part of the vehicle, the second element comprising a second part of the vehicle.

18. The apparatus of claim 1, wherein the detected target comprises a vehicle, the first element comprising a part of the vehicle, the second element comprising a human inside the vehicle.

19. The apparatus of claim 1, wherein the PC information comprises Light Detection and Ranging (LiDAR) PC information.

20. The apparatus of claim 1 comprising a Light Detection and Ranging (LiDAR) device comprising:
a LiDAR transmitter configured to emit laser light comprising a plurality of LiDAR transmit signals;
a LiDAR receiver configured to detect reflected laser light based on the plurality of LiDAR transmit signals; and
a LiDAR processor to generate the PC information.

21. The apparatus of claim 1 comprising a vehicle, the vehicle comprising a system controller to control one or more systems of the vehicle based on target information, the target information based on the output information.

22. A product comprising one or more tangible computer-readable non-transitory storage media comprising instructions operable to, when executed by at least one processor, enable the at least one processor to:
process Point Cloud (PC) information comprising velocity information corresponding to a plurality of points, wherein velocity information corresponding to a point of the plurality of points comprises a velocity value corresponding to the point;
identify a relative movement between a first element of a detected target and a second element of the detected target based on a first plurality of velocity values and a second plurality of velocity values, wherein the first plurality of velocity values corresponds to a plurality of first points corresponding to the first element, the second plurality of velocity values corresponding to a plurality of second points corresponding to the second element;
determine a predicted behavior detection corresponding to at least one of the detected target, the first element, or the second element, based on the relative movement between the first element and the second element; and
provide output information based on the PC information, wherein the output information is based on the predicted behavior detection.

23. The product of claim 22, wherein the instructions, when executed, cause the processor to determine a first movement vector corresponding to the first element based on the first plurality of velocity values, to determine a second movement vector corresponding to the second element based on the second plurality of velocity values, and to determine the relative movement between the first element and the second element based on the first movement vector and the second movement vector.

24. An apparatus comprising:
a processor configured to process Point Cloud (PC) information of a plurality of points, wherein the PC information comprises velocity information of the plurality of points, wherein velocity information of a point of the plurality of points comprises a velocity value, the processor configured to determine a predicted behavior detection corresponding to a detected target based on processing of PC information of no more than 3 PC frames; and
an output to provide output information based on the PC information, wherein the output information is based on the predicted behavior detection.

25. The apparatus of claim 24, wherein the processor is configured to determine the predicted behavior detection based on processing of PC information of a single PC frame.

26. The apparatus of claim 24, wherein the processor is configured to determine a relative movement between a first element of the detected target and a second element of the detected target based on the PC information, and to determine the predicted behavior detection based on the relative movement between the first element and the second element.
